(19) United States
(12) Patent Application Publication
(10) Pub. No.: US 2023/0344041 A1
(43) Pub. Date: Oct. 26, 2023

(54) POWER STORAGE DEVICE PACKAGING MATERIAL, METHOD FOR PRODUCING SAME, AND POWER STORAGE DEVICE

(71) Applicant: DAI NIPPON PRINTING CO., LTD., Tokyo (JP)

(72) Inventors: Makoto AMANO, Tokyo (JP); Daisuke YASUDA, Tokyo (JP); Masahiro TATSUZAWA, Tokyo (JP); Kazuhiko YOKOTA, Tokyo (JP); Takanori YAMASHITA, Tokyo (JP); Yasuaki MUTOU, Tokyo (JP); Jun KAGEYAMA, Tokyo (JP); Hironori KAMIJO, Tokyo (JP)

(73) Assignee: DAI NIPPON PRINTING CO., LTD., Tokyo (JP)

(21) Appl. No.: 18/035,122

(22) PCT Filed: Nov. 24, 2021
(86) PCT No.: PCT/JP2021/043054

§ 371 Date: May 3, 2023

(30) Foreign Application Priority Data
Nov. 25, 2020 (JP) 2020-195304
Nov. 25, 2020 (JP) 2020-195305

(51) Int. Cl. H01M 50/129; H01M 10/04

(52) U.S. Cl. CPC H01M 50/129; H01M 10/0481

(57) ABSTRACT

A power storage device packaging material includes a laminate having at least a base material layer, a barrier layer, and a heat-sealable resin layer sequentially from an outer side, wherein the base material layer includes a polyester film and a polyamide film, the polyester film has a thickness of 10 μm or more and 14 μm or less, and the polyamide film has a thickness of 18 μm or more and 22 μm or less.

### TECHNICAL FIELD

The present disclosure relates to a power storage device packaging material, a method for producing the power storage device packaging material, and a power storage device.

### BACKGROUND ART

Various types of power storage devices have heretofore been developed, and in every power storage device, a packaging material is an essential member for sealing power storage device elements including electrodes, an electrolyte, and the like. Metallic packaging materials have heretofore been widely used as power storage device packaging materials.

In recent years, along with improvements in the performance of electric cars, hybrid electric cars, personal computers, cameras, mobile phones, and the like, power storage devices have been required to have a variety of shapes and simultaneously to become thinner and lighter weight. However, the widely used metallic power storage device packaging materials are disadvantageous in that they have difficulty in keeping up with the diversification of shapes and are limited in weight reduction.

Thus, a film-shaped laminate in which a base material layer/a barrier layer/a heat-sealable resin layer are sequentially laminated has recently been proposed as a power storage device packaging material that can be readily processed into various shapes and can achieve a thickness reduction and a weight reduction (see Patent Literature 1, for example).

In such a power storage device packaging material, typically, a concave portion is formed by cold molding, power storage device elements including electrodes, an electrolytic solution, and the like are disposed in the space formed by the concave portion, and the heat-sealable resin layer is heat-sealed to another heat-sealable resin layer. This results in a power storage device in which the power storage device elements are housed inside the power storage device packaging material.

### CITATION LIST

### Patent Literature

Patent Literature 1: JP-A-2008-287971

### SUMMARY OF INVENTION

### Technical Problem

The film-shaped packaging material has recently been required to become even thinner. The packaging material has also been required to form a deep concave portion, from the viewpoint of further increasing the energy density of a power storage device, for example.

To improve the moldability of the film-shaped packaging material, for example, a polyamide film with excellent moldability may be used as a base material layer.

Unfortunately, when a power storage device packaging material in which a base material layer formed of the polyamide film, a barrier layer, and a heat-sealable resin layer are sequentially laminated is molded to form a concave portion for housing power storage device elements, peripheral portions of the concave portion may be curled (bent) after molding, which may inhibit housing of the power storage device elements or heat-sealing of the heat-sealable resin layers, and lead to a reduction in production efficiency of the power storage device.

Alternatively, a polyester film may be used as a base material layer to improve mechanical strength, because the film-shaped packaging material has an extremely small thickness.

Unfortunately, the polyester film is inferior in moldability to the polyamide film and thus, is susceptible to cracks or pinholes when a film-shaped power storage device packaging material in which the polyester film is used as a base material layer is molded to form a concave portion for housing power storage device elements.

Under such circumstances, it is a main object of a first aspect of the present disclosure to provide a power storage device packaging material that simultaneously achieves excellent moldability and reduced curling after molding, by using both a polyester film and a polyamide film as a base material layer.

Furthermore, power storage device elements contain components such as rare metals, and the demand for these components is rapidly increasing. Thus, in various products such as electrical devices, at the time of, for example, replacement of a power storage device, the power storage device needs to be removed from the product for recovering or recycling the various components contained in the power storage device elements.

In various products such as electrical devices, a power storage device is firmly fixed to the casing of the product with a double-sided tape, an adhesive, or the like. Thus, removal of the power storage device from the casing of the product involves applying a large external force to the power storage device. Specifically, the power storage device is typically removed from the casing using a metal spatula or the like, which involves applying a large external force to the power storage device. The application of a large external force to the power storage device packaging material formed of the film-shaped laminate, at the time of removal of the power storage device, may lead to breakage in the power storage device packaging material. Another problem is that the power storage device packaging material is susceptible to damage, such as shape loss and streaks or scratches, due to an impact to the power storage device.

Under such circumstances, it is a main object of a second aspect of the present disclosure to provide a power storage device packaging material that has reduced breakage in the power storage device packaging material at the time of separating a power storage device fixed to a casing with a double-sided tape or the like from the casing, and has reduced damage, such as shape loss and streaks or scratches, due to an impact to the power storage device.

### Solution to Problem

The inventors of the present disclosure have conducted extensive research to solve the aforementioned problem according to the first aspect of the present disclosure. As a result, they have found that a power storage device packaging material comprising a laminate comprising at least a base material layer, a barrier layer, and a heat-sealable resin layer, the base material layer comprising a polyester film and a polyamide film, wherein each of the polyester film and the polyamide film has a thickness adjusted in a specific range, unexpectedly simultaneously achieves excellent moldability and reduced curling after molding.

The first aspect of the present disclosure has been completed as a result of further research based on this novel finding. In summary, the present disclosure provides the first aspect of the invention as set forth below:

A power storage device packaging material comprising a laminate comprising at least a base material layer, a barrier layer, and a heat-sealable resin layer sequentially from an outer side,
wherein the base material layer comprises a polyester film and a polyamide film,
the polyester film has a thickness of 10 μm or more and 14 μm or less, and
the polyamide film has a thickness of 18 μm or more and 22 μm or less.

Furthermore, the inventors of the present disclosure have conducted extensive research to solve the aforementioned problem according to the second aspect of the present disclosure. As a result, they have found that a power storage device packaging material comprising a laminate comprising at least a base material layer, a barrier layer, and a heat-sealable resin layer sequentially from an outer side, wherein the base material layer comprises a polyamide film, the barrier layer comprises stainless steel, and the polyamide film has a crystallization index equal to or more than a predetermined value as measured from an outer side of the base material layer by Fourier transform infrared spectroscopy using ATR, has reduced breakage in the power storage device packaging material at the time of separating a power storage device fixed to a casing with a double-sided tape or the like from the casing, and has reduced damage, such as shape loss and streaks or scratches, due to an impact to the power storage device.

The second aspect of the present disclosure has been completed as a result of further research based on these findings. In summary, the present disclosure provides the second aspect of the invention as set forth below:

A power storage device packaging material comprising a laminate comprising at least a base material layer, a barrier layer, and a heat-sealable resin layer sequentially from an outer side,
wherein the base material layer comprises a polyamide film,
the barrier layer comprises stainless steel, and
the polyamide film has a crystallization index of 1.50 or more as measured from an outer side of the base material layer by Fourier transform infrared spectroscopy using ATR.

### Advantageous Effects of Invention

The first aspect of the present disclosure provides a power storage device packaging material that simultaneously achieves excellent moldability and reduced curling after molding, by using both a polyester film and a polyamide film as a base material layer. The first aspect of the present disclosure also provides a method for producing the power storage device packaging material and a power storage device obtained using the power storage device packaging material.

The second aspect of the present disclosure provides a power storage device packaging material that has reduced breakage in the power storage device packaging material at the time of separating a power storage device fixed to a casing with a double-sided tape or the like from the casing using a metal spatula or the like, and has reduced damage, such as shape loss and streaks or scratches, due to an impact to the power storage device. The second aspect of the present disclosure also provides a method for producing the power storage device packaging material and a power storage device obtained using the power storage device packaging material, as well as a polyamide film suitable for use as a base material layer in a power storage device packaging material.

### BRIEF DESCRIPTION OF DRAWINGS

FIG. 1 is a schematic diagram showing one exemplary cross-sectional structure of a power storage device packaging material of the present disclosure.

FIG. 2 is a schematic diagram showing one exemplary cross-sectional structure of a power storage device packaging material of the present disclosure.

FIG. 3 is a schematic diagram showing one exemplary cross-sectional structure of a power storage device packaging material of the present disclosure.

FIG. 4 is a schematic diagram showing one exemplary cross-sectional structure of a power storage device packaging material of the present disclosure.

FIG. 5 is a schematic diagram for illustrating a method of housing power storage device elements in a package formed of a power storage device packaging material of the present disclosure.

FIG. 6 is a schematic diagram for illustrating a method of evaluating curling after molding of the power storage device packaging material according to the first aspect.

FIG. 7 is a schematic diagram for illustrating a method of evaluating curling after molding of the power storage device packaging material according to the first aspect.

FIG. 8 is a graph for schematically illustrating a method of obtaining a baseline, in the measurement of the crystallization index of the base material layer in the power storage device packaging material of the present disclosure.

FIG. 9 is a schematic diagram for illustrating a procedure for preparing a sample for use in the power storage device separation test in examples according to the second aspect.

FIGS. 10(a) and 10(b) are a side view and a plan view, respectively, of the sample for use in the power storage device separation test in examples according to the second aspect.

FIGS. 11(a) and 11(b) are a side view and a plan view, respectively, of the sample for use in the power storage device separation test in examples according to the second aspect, with a double-sided tape applied thereto.

FIG. 12 is a schematic diagram showing the manner in which a power storage device is separated from a stainless steel plate using a metal spatula, in the power storage device separation test in examples according to the second aspect.

### DESCRIPTION OF EMBODIMENTS

A power storage device packaging material according to a first aspect of the present disclosure comprises a laminate comprising at least a base material layer, a barrier layer, and a heat-sealable resin layer sequentially from an outer side, wherein the base material layer comprises a polyester film and a polyamide film, the polyester film has a thickness of 10 μm or more and 14 μm or less, and the polyamide film has a thickness of 18 μm or more and 22 μm or less. The power storage device packaging material according to the first aspect of the present disclosure simultaneously achieves excellent moldability and reduced curling after molding.

A power storage device packaging material according to a second aspect of the present disclosure comprises a laminate comprising at least a base material layer, a barrier layer, and a heat-sealable resin layer sequentially from an outer side, wherein the base material layer comprises a polyamide film, the barrier layer comprises stainless steel, and the polyamide film has a crystallization index of 1.50 or more as measured from an outer side of the base material layer by Fourier transform infrared spectroscopy using ATR. The power storage device packaging material according to the second aspect of the present disclosure has reduced breakage in the power storage device packaging material at the time of separating a power storage device fixed to a casing with a double-sided tape or the like from the casing, and has reduced damage, such as shape loss and streaks or scratches, due to an impact to the power storage device.

Furthermore, in the production process of a power storage device, after power storage device elements including an electrolyte and the like are housed in a package formed of a molded power storage device packaging material, the power storage device elements are baked in a high-temperature environment (for example, about 80 to 120° C.) for the purpose of, for example, bringing the power storage device elements in close contact with each other.

This baking step is carried out with power storage devices stacked on one another, from the viewpoint of, for example, productivity (such as spatial constraints of baking). Thus, the power storage devices are transported and stacked in a high-temperature environment. During this time, the power storage device packaging material is susceptible to damage, such as shape loss and streaks or scratches, due to impacts to the power storage devices.

A preferred embodiment of the power storage device packaging material according to the second aspect of the present disclosure can further exhibit a superior effect of being resistant to damage in a high-temperature environment.

The power storage device packaging material of the present disclosure will be hereinafter described in detail. Regarding the numerical ranges recited herein in a stepwise manner, an upper or lower limit recited in a particular numerical range may be replaced by an upper or lower limit of another numerical range recited in a stepwise manner. Moreover, separately recited upper limits, separately recited upper and lower limits, or separately recited lower limits may be combined to define a numerical range. Furthermore, regarding the numerical ranges recited herein, an upper or lower limit recited in a particular numerical range may be replaced by a value shown in the examples. In the present specification, any numerical range indicated by “ . . . to . . . “is intended to mean” . . . or more“and” . . . or less”. For example, the recitation “2 to 15 mm” is intended to mean 2 mm or more and 15 mm or less.

In the present specification, the features related to the first or second aspect of the present disclosure are expressly indicated as the features related to the first or second aspect, respectively, whereas the common features between the first and second aspects are described collectively as being related to the present disclosure, without distinguishing between the first and second aspects.

1. Laminated Structure and Physical Properties of Power Storage Device Packaging Material

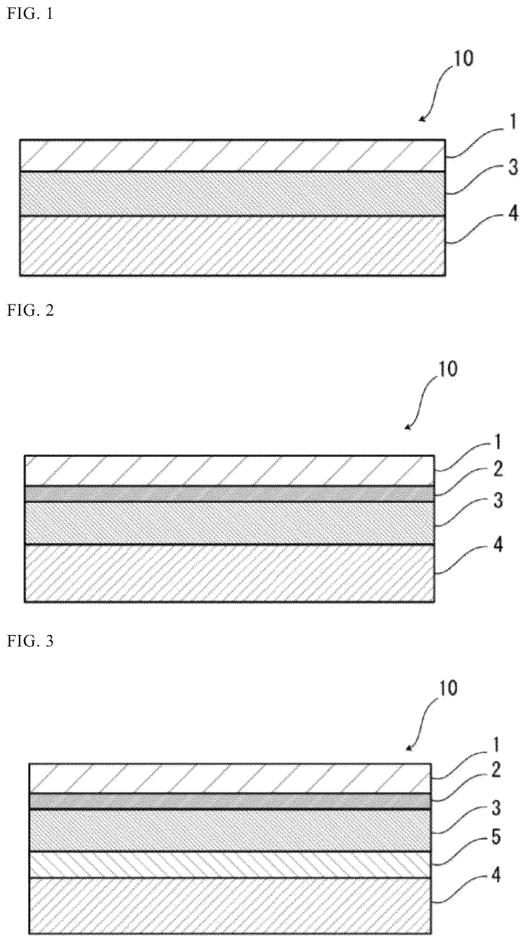

As shown in FIG. 1, for example, a power storage device packaging material 10 of the present disclosure comprises a laminate comprising a base material layer 1, a barrier layer 3, and a heat-sealable resin layer 4 in this order. In the power storage device packaging material 10, the base material layer 1 is the outermost layer, and the heat-sealable resin layer 4 is the innermost layer. At the time of assembly of a power storage device using the power storage device packaging material 10 and power storage device elements, the power storage device elements are housed in a space formed by heat-sealing peripheral portions of the opposing heat-sealable resin layers 4 of the power storage device packaging material 10. In the laminate constituting the power storage device packaging material 10 of the present disclosure, using the barrier layer 3 as the reference, the heat-sealable resin layer 4 side relative to the barrier layer 3 is defined as the inner side, and the base material layer 1 side relative to the barrier layer 3 is defined as the outer side.

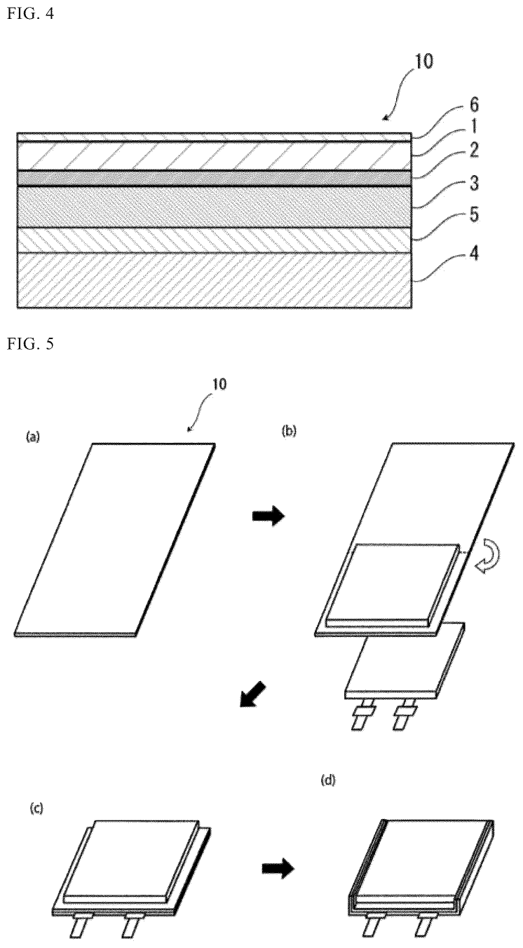

As shown in FIGS. 2 to 4, for example, the power storage device packaging material 10 of the present disclosure may optionally have an adhesive agent layer 2 between the base material layer 1 and the barrier layer 3, for the purpose of, for example, improving the adhesiveness between these layers. Moreover, as shown in FIGS. 3 and 4, for example, the power storage device packaging material 10 may also optionally have an adhesive layer 5 between the barrier layer 3 and the heat-sealable resin layer 4, for the purpose of, for example, improving the adhesiveness between these layers. Furthermore, as shown in FIG. 4, a surface coating layer 6 or the like may be optionally provided on an outer side of the base material layer 1 (opposite to the heat-sealable resin layer 4 side).

While the thickness of the laminate constituting the power storage device packaging material 10 of the present disclosure is not limited, it is preferably about 190 μm or less, about 180 μm or less, about 165 μm or less, about 158 μm or less, about 157 μm or less, about 153 μm or less, or about 120 μm or less, from the viewpoint of reducing costs or improving the energy density, for example. On the other hand, from the viewpoint of maintaining the function of the power storage device packaging material to protect the power storage device elements, the thickness of the laminate constituting the power storage device packaging material 10 is preferably about 35 μm or more, about 45 μm or more, or about 60 μm or more. Preferred ranges of the thickness of the laminate constituting the power storage device packaging material 10 include, for example, from about 35 to 190 μm, from about 35 to 180 μm, from about 35 to 165 μm, from about 35 to 158 μm, from about 35 to 157 μm, from about 35 to 153 μm, from about 35 to 120 μm, from about 45 to 190 μm, from about 45 to 180 μm, from about 45 to 165 μm, from about 45 to 158 μm, from about 45 to 157 μm, from about 45 to 153 μm, from about 45 to 120 μm, from about 60 to 190 μm, from about 60 to 180 μm, from about 60 to 165 μm, from about 60 to 158 μm, from about 60 to 157 μm, from about 60 to 153 μm, and from about 60 to 120 μm, with the range of about 60 to 153 μm being particularly preferred.

In the power storage device packaging material 10 of the present disclosure, the ratio of the sum thickness of the base material layer 1, the optional adhesive agent layer 2, the barrier layer 3, the optional adhesive layer 5, the heat-sealable resin layer 4, and the optional surface coating layer 6, relative to the thickness (total thickness) of the laminate constituting the power storage device packaging material 10, is preferably 90% or more, more preferably 95% or more, and still more preferably 98% or more. As a specific example, when the power storage device packaging material 10 of the present disclosure includes the base material layer 1, the adhesive agent layer 2, the barrier layer 3, the adhesive layer 5, and the heat-sealable resin layer 4, the ratio of the sum thickness of these layers relative to the thickness (total thickness) of the laminate constituting the power storage device packaging material 10 is preferably 90% or more, more preferably 95% or more, and still more preferably 98% or more. Similarly when the power storage device packaging material 10 of the present disclosure is a laminate including the base material layer 1, the adhesive agent layer 2, the barrier layer 3, and the heat-sealable resin layer 4, the ratio of the sum thickness of these layers relative to the thickness (total thickness) of the laminate constituting the power storage device packaging material 10 may be, for example, 80% or more, preferably 90% or more, more preferably 95% or more, and still more preferably 98% or more.

Preferably, the polyamide film contained in the base material layer 1 of the power storage device packaging material 10 according to the first aspect of the present disclosure has a crystallization index of 1.50 or more as measured by Fourier transform infrared spectroscopy using ATR. This simultaneously achieves excellent moldability and reduced curling after molding in the power storage device packaging material 10 according to the first aspect and can also increase the mechanical strength of the power storage device packaging material 10.

The base material layer 1 of the power storage device packaging material 10 according to the second aspect of the present disclosure comprises a polyamide film, and the polyamide film has a crystallization index of 1.50 or more as measured from an outer side of the base material layer 1 by Fourier transform infrared spectroscopy using ATR.

The method of measuring the crystallization index of the polyamide film contained in the base material layer 1 of the power storage device packaging material 10 of the present disclosure is as follows.

<Measurement of Crystallization Index of Base Material Layer in Power Storage Device Packaging Material>

The power storage device packaging material is cut into a 100 mm×100 mm square. When the polyester film is laminated on the outer side relative to the polyamide film, a measurement sample is prepared by cutting the polyester film on the polyamide film of the base material layer to expose the surface of the polyamide film, using the following procedure, as employed in the below-described examples. To expose the surface of the polyamide film, an ultramicrotome (for example, Leica EM UC7 from Leica Microsystems) is used to horizontally slice the polyester film in the measurement sample to cut away the polyester film and the adhesive agent layer approximately in the parallel direction. Next, the surface of the ONy film positioned on an outer side of the resulting measurement sample is subjected to infrared absorption spectrum measurement in an environment at a temperature of 25° C. and a relative humidity of 50%, using the ATR measurement mode of FT-IR. For example, Nicolet iS10 from Thermo Fisher Scientific Co., Ltd. may be used as the apparatus. From the obtained absorption spectrum, the peak intensity P near 1200 cm⁻¹ due to the absorption of the α-crystal of nylon and the peak intensity Q near 1370 cm⁻¹ due to absorption not associated with the crystal are measured, and the intensity ratio of the peak intensity P to the peak intensity Q, X=P/Q, is calculated as the crystallization index. When the power storage device packaging material is obtained from a power storage device to measure the crystallization index of the base material layer, the power storage device packaging material is obtained from a top or bottom surface of the power storage device, and not from the heat-sealed portions or a side surface of the power storage device, to prepare a sample.

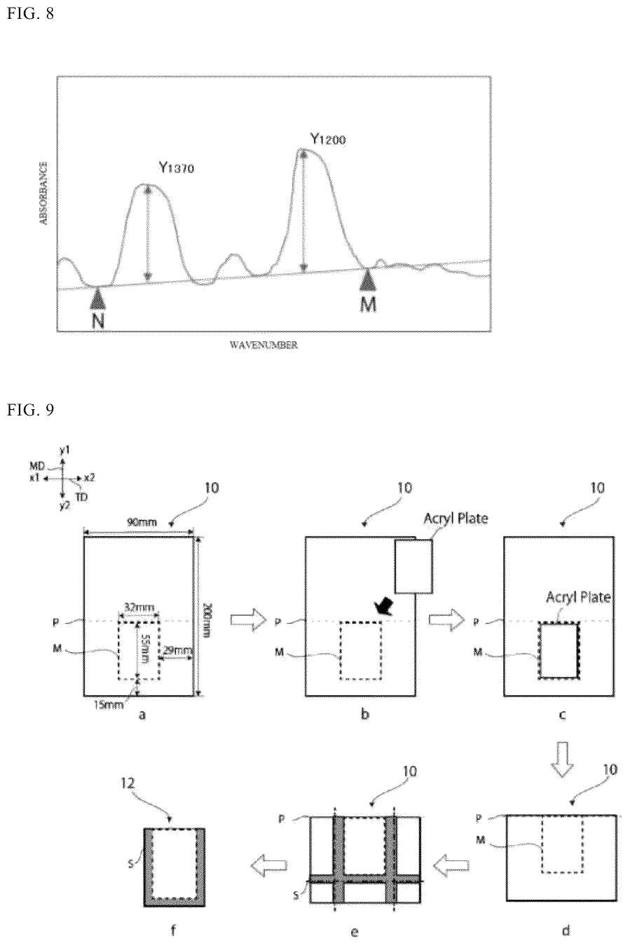

(Measurement Conditions)
Method: Macro ATR
Wavenumber resolution: 8 cm⁻¹
Accumulation times: 32
Detector: DTGS detector
ATR prism: Ge
Incident angle: 45°
Baseline: The baseline is obtained by connecting two points, i.e., the first valley on the low wavenumber side of the absorption peak intensity Y₁₂₀₀ and the first valley on the high wavenumber side of the absorption peak intensity Y₁₃₇₀, with a straight line. See the schematic diagram in FIG. 8. In FIG. 8, the right side of the horizontal axis (WAVENUMBER) corresponds to the low wavelength side, and the left side of the horizontal axis (WAVENUMBER) corresponds to the high wavelength side. The position indicated by M is “the first valley on the low wavenumber side of the absorption peak intensity YI₂₀₀”, and the position indicated by N is “the first valley on the high wavenumber side of the absorption peak intensity Y₁₃₇₀”.

Absorption peak intensity Y₁₂₀₀: a value obtained by subtracting the baseline value from the maximum value of peak intensity in the wavenumber range of 1195 cm⁻¹ to 1205 cm⁻¹

Absorption peak intensity Y₁₃₇₀: a value obtained by subtracting the baseline value from the maximum value of peak intensity in the wavenumber range of 1365 cm⁻¹ to 1375 cm⁻¹

When an outer surface of the power storage device packaging material 10 according to the first aspect is formed of the polyamide film of the base material layer 1, the power storage device packaging material 10 may be used as is for measurement of crystallization index. When the outer surface of the power storage device packaging material 10 is not formed of the polyamide film of the base material layer 1, for example, when a resin film different from the polyamide film (for example, the polyester film as described above) is positioned on the outer side relative to the polyamide film, or when the below-described surface coating layer 6 is laminated on the outer side of the base material layer 1, the layer positioned on the outer side relative to the polyamide film may be removed from the power storage device packaging material 10, and the crystallization index may be measured with the surface of the polyamide film being exposed.

In the power storage device packaging material 10 according to the first aspect, the crystallization index as described above is preferably 1.50 or more, more preferably 1.55 or more, still more preferably 1.60 or more, and particularly preferably 1.65 or more. While the upper limit of the crystallization index is not limited, it is, for example, 2.50 or less, or 1.80 or less. Preferred ranges of the crystallization index include, for example, from 1.50 to 2.50, from 1.55 to 2.50, from 1.60 to 2.50, from 1.65 to 2.50, from 1.50 to 1.80, from 1.55 to 1.80, from 1.60 to 1.80, and from 1.65 to 1.80.

When an outer surface of the power storage device packaging material 10 according to the second aspect is formed of the polyamide film of the base material layer 1, the power storage device packaging material 10 may be used as is for measurement of crystallization index. When the outer surface of the power storage device packaging material 10 is not formed of the polyamide film of the base material layer 1, for example, when the base material layer 1 has a multilayer structure as described below, and a resin film different from the polyamide film (for example, the polyester film) is positioned on the outer side relative to the polyamide film, or when the below-described surface coating layer 6 is laminated on the outer side of the base material layer 1, the layer positioned on the outer side relative to the polyamide film may be removed from the power storage device packaging material 10, and the crystallization index may be measured with the surface of the polyamide film being exposed.

In the power storage device packaging material 10 according to the second aspect, the crystallization index may be any value in the range of 1.50 or more; however, it is more preferably 1.55 or more, still more preferably 1.60 or more, and particularly preferably 1.65 or more, from the viewpoint of more effectively reducing breakage in the power storage device packaging material at the time of separation as described above. While the upper limit of the crystallization index is not limited, it is, for example, 2.50 or less, or 1.80 or less. Preferred ranges of the crystallization index include, for example, from 1.50 to 2.50, from 1.55 to 2.50, from 1.60 to 2.50, from 1.65 to 2.50, from 1.50 to 1.80, from 1.55 to 1.80, from 1.60 to 1.80, and from 1.65 to 1.80.

In the present disclosure, one method of increasing the crystallization index of the polyamide film contained in the base material layer 1 of the power storage device packaging material 10 to 1.50 or more may be, for example, to promote crystallization (promote α-crystal formation) by adjusting the stretch ratio, the heat-setting temperature, and the post-heating temperature and time, for example, in the production process of the polyamide film.

The power storage device packaging material 10 preferably has a black color. The black color appearance of the power storage device packaging material 10 can impart a luxury feeling to a product if, for example, a power storage device and other electrical components are also made uniformly black in color. Moreover, the black color appearance of the power storage device packaging material 10 also has the advantage of making any damage such as scratches easily visible and allowing a determination of the safety of the battery to be easily made.

2. Layers Forming Power Storage Device Packaging Material

[Base Material Layer 1]

In the present disclosure, the base material layer 1 is a layer that is provided for the purpose of, for example, functioning as a base material of the power storage device packaging material. The base material layer 1 is positioned on the outer layer side of the power storage device packaging material.

The base material layer 1 of the first aspect comprises the polyester film and the polyamide film, each having a predetermined thickness.

In the first aspect, specific examples of polyesters forming the polyester film include polyethylene terephthalate, polybutylene terephthalate, polyethylene naphthalate, polybutylene naphthalate, polyethylene isophthalate, and copolyesters. Examples of copolyesters include copolyesters containing ethylene terephthalate as a main repeating unit. Specific examples include copolyesters obtained by polymerizing the main repeating unit ethylene terephthalate with ethylene isophthalate (abbreviated as polyethylene (terephthalate/isophthalate); hereinafter similarly abbreviated), polyethylene (terephthalate/adipate), polyethylene (terephthalate/sodium sulfoisophthalate), polyethylene (terephthalate/sodium isophthalate), polyethylene (terephthalate/phenyl-dicarboxylate), and polyethylene (terephthalate/decane dicarboxylate). These polyesters may be used alone or in combination. Preferred among these are polyethylene terephthalate and polybutylene terephthalate.

In the first aspect, the polyester film is preferably a stretched polyester film, and more preferably a biaxially stretched polyester film.

In the first aspect, the polyester film is particularly preferably a biaxially stretched polyethylene terephthalate film or a biaxially stretched polybutylene terephthalate film.

In the first aspect, the thickness of the polyester film may be any value in the range of 10 to 14 μm; however, preferred ranges include from about 11 to 14 μm, from about 11 to 13 μm, from about 11 to 12 μm, from about 12 to 14 μm, and from about 12 to 13 μm, from the viewpoint of more satisfactorily achieving the effect of the power storage device packaging material according to the first aspect.

In the first aspect, specific examples of polyamides include aliphatic polyamides, such as nylon 6, nylon 66, nylon 610, nylon 12, nylon 46, and copolymers of nylon 6 and nylon 66; polyamides containing aromatics, such as hexamethylenediamine-isophthalic acid-terephthalic acid copolyamides containing structural units derived from terephthalic acid and/or isophthalic acid, for example, nylon 6I, nylon 6T, nylon 6IT, and nylon 616T (1 denotes isophthalic acid, and T denotes terephthalic acid), and polyamide MXD6 (polymethaxylylene adipamide); cycloaliphatic polyamides, such as polyamide PACM6 (polybis(4-aminocyclohexyl)methane adipamide); polyamides copolymerized with a lactam component or an isocyanate component such as 4,4′-diphenylmethane-diisocyanate, and polyester amide copolymers or polyether ester amide copolymers that are copolymers of copolyamides with polyesters or polyalkylene ether glycols; and copolymers thereof. These polyamides may be used alone or in combination.

In the first aspect, the polyamide forming the polyamide film is particularly preferably a polyamide having an α-crystal content, and specific examples include aliphatic polyamides, such as nylon 6, nylon 66, nylon 46, and a copolymer of nylon 6 and nylon 66. These polyamides may be used alone or in combination. The polyamide film is preferably a nylon film.

In the first aspect, the polyamide film may be an unstretched film or a stretched film. When the base material layer 1 contains an unstretched film, at the time of laminating each layer of the power storage device packaging material 10, an unstretched film may be formed by extrusion molding, a previously prepared unstretched film may be bonded, or an unstretched film may be formed by applying a resin (polyamide). Examples of methods of applying the resin include a roll coating method, a gravure coating method, and an extrusion coating method. When the base material layer 1 is a stretched film, a previously prepared stretched film is bonded at the time of laminating each layer of the power storage device packaging material 10. The stretched film is, for example, a uniaxially stretched film or a biaxially stretched film, preferably a biaxially stretched film. Examples of stretching methods for forming a biaxially stretched film include a sequential biaxial stretching method, an inflation method, and a simultaneous biaxial stretching method.

In the first aspect, the polyamide film is particularly preferably a biaxially stretched nylon film.

In the first aspect, the crystallization index of the polyamide film is preferably 1.50 or more, as described above.

The power storage device packaging material 10 according to the first aspect of the present disclosure may be produced using, as the base material layer 1, the polyamide film having a crystallization index of 1.50 or more as measured by Fourier transform infrared spectroscopy using ATR. Alternatively, in the production process of the power storage device packaging material 10, heat may be applied to the polyamide film to increase the crystallization index to 1.50 or more. Preferably, the power storage device packaging material 10 according to the first aspect is produced using, as the base material layer 1, the polyamide film having a crystallization index of 1.50 or more as measured by Fourier transform infrared spectroscopy using ATR. That is, the power storage device packaging material 10 according to the first aspect is preferably produced by using, as the base material layer 1, a polyamide film in which the crystallization index has been previously adjusted to 1.50 or more, and laminating the polyamide film with a layer such as the barrier layer 3 or the heat-sealable resin layer 4. As described in the examples below, the crystallization index of the polyamide film contained in the base material layer 1 after being laminated on the power storage device packaging material 10 can be increased more than the crystallization index of the polyamide film before being applied to the power storage device packaging material 10.

In the first aspect, the thickness of the polyamide film may be any value in the range of 18 to 22 μm; however, preferred ranges include from about 18 to 21 μm, from about 18 to 20 μm, from about 19 to 21 μm, and from about 19 to 20 μm, from the viewpoint of more satisfactorily achieving the effect of the power storage device packaging material according to the first aspect.

In the first aspect, the thickness ratio of the polyamide film, relative to the thickness of the polyester film taken as 1, is preferably about 1.3 to 2.2, more preferably about 1.5 to 1.9, and still more preferably about 1.6 to 1.8.

In the first aspect, the thickness ratio of the polyamide film, relative to the thickness of the barrier layer 3 taken as 1, is preferably about 0.45 to 0.61. As a specific example, when the below-described barrier layer 3 contains an aluminum alloy foil, the thickness ratio of the polyamide film, relative to the thickness of the aluminum alloy foil taken as 1, is preferably about 0.45 to 0.61.

In the first aspect, the thickness ratio of the polyamide film, relative to the thickness of the heat-sealable resin layer 4 taken as 1, is preferably about 0.25 to 0.69, and more preferably about 0.40 to 0.65. As a specific example, when the below-described heat-sealable resin layer 4 contains a layer formed of polypropylene (polypropylene layer), the thickness ratio of the polyamide film, relative to the thickness of the polypropylene layer taken as 1, is preferably about 0.25 to 0.69, and more preferably about 0.40 to 0.65.

In the first aspect, (the thickness (μm) of the polyamide film/the sum value of the thickness (μm) of the adhesive layer 5)+the thickness (μm) of the heat-sealable resin layer 4 is preferably about 0.20 to 0.34, and more preferably about 0.22 to 0.31. As a specific example, when the below-described heat-sealable resin layer 4 contains a layer formed of polypropylene (polypropylene layer), the below-described adhesive layer 5 contains a layer formed of an acid-modified polypropylene (acid-modified polypropylene layer), and the total thickness of the layers on the inner side relative to the barrier layer of the laminate constituting the power storage device packaging material 10 is taken as 1, (the thickness (μm) of the polyamide film/the sum value of the thickness (μm) of the acid-modified polypropylene layer)+the thickness (μm) of the polypropylene layer is preferably about 0.20 to 0.34, and more preferably about 0.22 to 0.31.

In the first aspect, the thickness ratio of the polyamide film, relative to the total thickness of the laminate constituting the power storage device packaging material 10 taken as 1, is preferably about 0.11 to 0.15, and more preferably about 0.12 to 0.14.

In the first aspect, the base material layer 1 may be a laminate obtained by laminating the polyester film and the polyamide film with an adhesive or the like, or may be a laminate obtained by laminating the polyester and the polyamide by co-extrusion. The laminate obtained by laminating the polyester and the polyamide by co-extrusion may be used in an unstretched state as the base material layer 1, or may be uniaxially or biaxially stretched and used as the base material layer 1.

In the first aspect, the base material layer 1 preferably contains only the polyester film and the polyamide film as resin films; however, the base material layer 1 may further contain a resin film different from the polyester film and the polyamide film. Examples of the resin forming the resin film different from the polyamide film include resins such as polyolefins, epoxy resins, acrylic resins, fluororesins, polyurethanes, silicone resins, and phenol resins, as well as modified resins thereof. The resin may also be a copolymer of these resins or a modified copolymer thereof. The resin may also be a mixture of these resins.

In the first aspect, similarly when the base material layer 1 further contains another resin film different from the polyester film and the polyamide film, the base material layer 1 may be a laminate obtained by laminating the polyester film, the polyamide film, and the other resin film with an adhesive or the like, or may be a laminate obtained by laminating the resins by co-extrusion. The laminate of the resin films obtained by co-extruding the resins may be used in an unstretched state as the base material layer 1, or may be uniaxially or biaxially stretched and used as the base material layer 1.

In the first aspect, a specific example of the base material layer 1 is a laminate of a polyester film and a nylon film, with a laminate of a stretched polyester film and a stretched nylon film being preferred. The polyester film is preferably positioned as the outermost layer of the base material layer 1, because the polyester is resistant to discoloration when, for example, the electrolytic solution adheres to the surface.

In the first aspect, the method of laminating two or more layers of resin films is not limited, and may be any of known methods, for example, a dry lamination method, a sandwich lamination method, an extrusion lamination method, and a thermal lamination method, preferably a dry lamination method. When the lamination is performed using a dry lamination method, a polyurethane adhesive is preferably used as an adhesive. In this case, the thickness of the adhesive is, for example, about 2 to 5 μm. An anchor coat layer may also be formed and laminated on the resin films. Examples of the anchor coat layer are the same adhesives as those mentioned for the below-described adhesive agent layer 2. In this case, the thickness of the anchor coat layer is, for example, about 0.01 to 1.0 μm.

In the second aspect, the base material layer 1 comprises a polyamide film. As described above, the polyamide film has a crystallization index of 1.50 or more as measured from an outer side of the base material layer 1 by Fourier transform infrared spectroscopy using ATR. In the second aspect, the above-defined crystallization index is satisfied, and the barrier layer 3 comprises stainless steel as described above, which allows the power storage device packaging material to satisfactorily exhibit the property of having reduced breakage in the power storage device packaging material at the time of separating a power storage device fixed to a casing with a double-sided tape or the like from the casing using a metal spatula or the like, and having reduced damage, such as shape loss and streaks or scratches, due to an impact to the power storage device.

In the second aspect, the polyamide forming the polyamide film may be any polyamide having an α-crystal content, and specific examples include aliphatic polyamides, such as nylon 6, nylon 66, nylon 46, and a copolymer of nylon 6 and nylon 66. These polyamides may be used alone or in combination. The polyamide film is preferably a nylon film.

In the second aspect, the polyamide film may be an unstretched film or a stretched film. When the base material layer 1 contains an unstretched film, at the time of laminating each layer of the power storage device packaging material 10, an unstretched film may be formed by extrusion molding, a previously prepared unstretched film may be bonded, or an unstretched film may be formed by applying a resin (polyamide). Examples of methods of applying the resin include a roll coating method, a gravure coating method, and an extrusion coating method. When the base material layer 1 is a stretched film, a previously prepared stretched film is bonded at the time of laminating each layer of the power storage device packaging material 10. The stretched film is, for example, a uniaxially stretched film or a biaxially stretched film, preferably a biaxially stretched film. Examples of stretching methods for forming a biaxially stretched film include a sequential biaxial stretching method, an inflation method, and a simultaneous biaxial stretching method.

In the second aspect, the polyamide film is particularly preferably a biaxially stretched nylon film.

The power storage device packaging material 10 according to the second aspect of the present disclosure may be produced using, as the base material layer 1, the polyamide film having a crystallization index of 1.50 or more as measured by Fourier transform infrared spectroscopy using ATR. Alternatively, in the production process of the power storage device packaging material 10, heat may be applied to the polyamide film to increase the crystallization index to 1.50 or more. As described in the “5. Polyamide Film” section below, preferably, the power storage device packaging material 10 according to the second aspect is produced using, as the base material layer 1, the polyamide film having a crystallization index of 1.50 or more as measured by Fourier transform infrared spectroscopy using ATR. That is, the power storage device packaging material 10 according to the second aspect is preferably produced by using, as the base material layer 1, a polyamide film in which the crystallization index has been previously adjusted to 1.50 or more, and laminating the polyamide film with a layer such as the barrier layer 3 or the heat-sealable resin layer 4. As described in the examples below, the crystallization index of the polyamide film contained in the base material layer 1 after being laminated on the power storage device packaging material 10 can be increased more than the crystallization index of the polyamide film before being applied to the power storage device packaging material 10.

In the second aspect, from the viewpoint of more effectively reducing breakage in the power storage device packaging material at the time of separation as described above, the thickness of the polyamide film is preferably about 50 μm or less, more preferably about 35 μm or less, still more preferably about 19 μm or less, even more preferably about 15 μm or less, still more preferably about 14 μm or less, and even more preferably about 13 μm or less, while it is preferably about 3 μm or more, more preferably about 5 μm or more, still more preferably about 6 μm or more, even more preferably about 7 μm or more, and still more preferably about 10 μm or more. Preferred ranges include from about 3 to 50 μm, from about 3 to 35 μm, from about 3 to 19 μm, from about 3 to 15 μm, from about 3 to 14 μm, from about 3 to 13 μm, from about 5 to 50 μm, from about 5 to 35 μm, from about 5 to 19 μm, from about 5 to 15 μm, from about 5 to 14 μm, from about 5 to 13 μm, from about 6 to 50 μm, from about 6 to 35 μm, from about 6 to 19 μm, from about 6 to 15 μm, from about 6 to 14 μm, from about 6 to 13 μm, from about 7 to 50 μm, from about 7 to 35 μm, from about 7 to 19 μm, from about 7 to 15 μm, from about 7 to 14 μm, from about 7 to 13 μm, from about 10 to 50 μm, from about 10 to 35 μm, from about 10 to 19 μm, from about 10 to 15 μm, from about 10 to 14 μm, and from about 10 to 13 μm, with the range of about 10 to 19 μm being particularly preferred among the above. Furthermore, from the viewpoint of reducing the occurrence of delamination of the base material layer 1 in a high temperature and humidity environment, the thickness of the polyamide film is desirably smaller. From this viewpoint, the thickness of the polyamide film is preferably about 15 μm or less, more preferably about 14 μm or less, and still more preferably about 13 μm or less.

In the second aspect, the base material layer 1 may further contain a resin film different from the polyamide film. Examples of the resin forming the resin film different from the polyamide film include resins such as polyesters, polyolefins, epoxy resins, acrylic resins, fluororesins, polyurethanes, silicone resins, and phenol resins, as well as modified resins thereof. The resin may also be a copolymer of these resins or a modified copolymer thereof. The resin may also be a mixture of these resins. Preferred among the above is a polyester, for example.

In the second aspect, specific examples of polyesters include polyethylene terephthalate, polybutylene terephthalate, polyethylene naphthalate, polybutylene naphthalate, polyethylene isophthalate, and copolyesters. Examples of copolyesters include copolyesters containing ethylene terephthalate as a main repeating unit. Specific examples include copolyesters obtained by polymerizing the main repeating unit ethylene terephthalate with ethylene isophthalate (abbreviated as polyethylene (terephthalate/isophthalate); hereinafter similarly abbreviated), polyethylene (terephthalate/adipate), polyethylene (terephthalate/sodium sulfoisophthalate), polyethylene (terephthalate/sodium isophthalate), polyethylene (terephthalate/phenyl-dicarboxylate), and polyethylene (terephthalate/decane dicarboxylate). These polyesters may be used alone or in combination. Preferred among these are polyethylene terephthalate and polybutylene terephthalate.

In the second aspect, the polyester film is preferably a stretched polyester film, and more preferably a biaxially stretched polyester film.

In the second aspect, the polyester film is particularly preferably a biaxially stretched polyethylene terephthalate film or a biaxially stretched polybutylene terephthalate film.

In the second aspect, when the base material layer 1 further has a resin film different from the polyamide film, the thickness of the other resin film is not limited as long as it does not interfere with the effect of the second aspect of the present disclosure; however, from the viewpoint of reducing costs or improving the energy density, for example, it is preferably about 50 μm or less, more preferably about 35 μm or less, and still more preferably about 19 μm or less, while it is preferably about 3 μm or more, and more preferably about 10 μm or more. Preferred ranges include from about 3 to 50 μm, from about 3 to 35 μm, from about 3 to 19 μm, from about 10 to 50 μm, from about 10 to 35 μm, and from about 10 to 19 μm, with the range of about 10 to 19 μm being particularly preferred among the above.

In the second aspect, the thickness ratio of the polyamide film, relative to the thickness of the barrier layer 3 taken as 1, is preferably about 0.30 to 1.30, and more preferably about 0.40 to 0.62. As a specific example, when the below-described barrier layer 3 contains an aluminum alloy foil, the thickness ratio of the polyamide film, relative to the thickness of the aluminum alloy foil taken as 1, is preferably about 0.30 to 1.30, and more preferably about 0.40 to 0.62.

In the second aspect, the thickness ratio of the polyamide film, relative to the thickness of the heat-sealable resin layer 4 taken as 1, is preferably about 0.25 to 0.69, and more preferably about 0.40 to 0.65. As a specific example, when the below-described heat-sealable resin layer 4 contains a layer formed of polypropylene (polypropylene layer), the thickness ratio of the polyamide film, relative to the thickness of the polypropylene layer taken as 1, is preferably about 0.25 to 0.69, and more preferably about 0.40 to 0.65.

In the second aspect, (the thickness (μm) of the polyamide film/the sum value of the thickness (μm) of the adhesive layer 5)+the thickness (μm) of the heat-sealable resin layer 4 is preferably about 0.20 to 0.34, and more preferably about 0.22 to 0.31. As a specific example, when the below-described heat-sealable resin layer 4 contains a layer formed of polypropylene (polypropylene layer), the below-described adhesive layer 5 contains a layer formed of an acid-modified polypropylene (acid-modified polypropylene layer), and the total thickness of the layers on the inner side relative to the barrier layer of the laminate constituting the power storage device packaging material 10 is taken as 1, (the thickness (μm) of the polyamide film/the sum value of the thickness (μm) of the acid-modified polypropylene layer)+the thickness (μm) of the polypropylene layer is preferably about 0.20 to 0.34, and more preferably about 0.22 to 0.31.

In the second aspect, the thickness ratio of the polyamide film, relative to the total thickness of the laminate constituting the power storage device packaging material 10 taken as 1, is preferably about 0.11 to 0.20.

In the second aspect, the base material layer 1 may be a single layer or may be composed of two or more layers as long as it comprises the polyamide film. From the viewpoint of reducing the thickness of the power storage device packaging material 10, the base material layer 1 is preferably a single layer of the polyamide film.

In the second aspect, when the base material layer 1 is composed of two or more layers, the base material layer 1 may be a laminate obtained by laminating the resin films with an adhesive or the like, or may be a laminate of the resin films obtained by co-extruding the resins into two or more layers. The laminate of the resin films obtained by co-extruding the resins into two or more layers may be used in an unstretched state as the base material layer 1, or may be uniaxially or biaxially stretched and used as the base material layer 1.

In the second aspect, specific examples of the laminate of two or more layers of resin films in the base material layer 1 include a laminate of a polyester film and a nylon film and a laminate of two or more layers of nylon films, with a laminate of a stretched nylon film and a stretched polyester film and a laminate of two or more layers of stretched nylon films being preferred. For example, when the base material layer 1 is a laminate of two layers of resin films, the laminate is preferably a laminate of a polyamide resin film and a polyamide resin film or a laminate of a polyester resin film and a polyamide resin film, and more preferably a laminate of a nylon film and a nylon film or a laminate of a polyethylene terephthalate film and a nylon film. When the base material layer 1 is a laminate of two or more layers of resin films, the polyester resin film is preferably positioned as the outermost layer of the base material layer 1, because the polyester resin is resistant to discoloration when, for example, the electrolytic solution adheres to the surface.

In the second aspect, when the base material layer 1 is a laminate of two or more layers of resin films, the two or more layers of resin films may be laminated via an adhesive. Examples of preferred adhesives are the same adhesives as those mentioned for the below-described adhesive agent layer 2. The method of laminating two or more layers of resin films is not limited, and may be any of known methods, for example, a dry lamination method, a sandwich lamination method, an extrusion lamination method, and a thermal lamination method, preferably a dry lamination method. When the lamination is performed using a dry lamination method, a polyurethane adhesive is preferably used as an adhesive. In this case, the thickness of the adhesive is, for example, about 2 to 5 μm. An anchor coat layer may also be formed and laminated on the resin films. Examples of the anchor coat layer are the same adhesives as those mentioned for the below-described adhesive agent layer 2. In this case, the thickness of the anchor coat layer is, for example, about 0.01 to 1.0 μm.

In the present disclosure, at least one of a surface and an inside of the base material layer 1 may contain additives, such as lubricants, flame retardants, anti-blocking agents, antioxidants, light stabilizers, tackifiers, and anti-static agents. A single additive may be used alone, or a mixture of two or more additives may be used.

In the present disclosure, a lubricant is preferably present on the surface of the base material layer 1, from the viewpoint of improving the moldability of the power storage device packaging material. While the lubricant is not limited, it is preferably an amide-based lubricant. Specific examples of amide-based lubricants include saturated fatty acid amides, unsaturated fatty acid amides, substituted amides, methylol amides, saturated fatty acid bis-amides, unsaturated fatty acid bis-amides, fatty acid ester amides, and aromatic bis-amides. Specific examples of saturated fatty acid amides include lauramide, palmitamide, stearamide, behenamide, and hydroxystearamide. Specific examples of unsaturated fatty acid amides include oleamide and erucamide. Specific examples of substituted amides include N-oleyl palmitamide, N-stearyl stearamide, N-stearyl oleamide, N-oleyl stearamide, and N-stearyl erucamide. Specific examples of methylol amides include methylol stearamide. Specific examples of saturated fatty acid bis-amides include methylene-bis-stearamide, ethylene-bis-capramide, ethylene-bis-lauramide, ethylene-bis-stearamide, ethylene-bis-hydroxystearamide, ethylene-bis-behenamide, hexamethylene-bis-stearamide, hexamethylene-bis-behenamide, hexamethylene hydroxystearamide, N,N′-distearyl adipamide, and N,N′-distearyl sebacamide. Specific examples of unsaturated fatty acid bis-amides include ethylene-bis-oleamide, ethylene-bis-erucamide, hexamethylene-bis-oleamide, N,N′-dioleyl adipamide, and N,N′-dioleyl sebacamide. Specific examples of fatty acid ester amides include stearamide ethyl stearate. Specific examples of aromatic bis-amides include m-xylylene-bis-stearamide, m-xylylene-bis-hydroxystearamide, and N,N′-distearyl isophthalamide. These lubricants may be used alone or in combination.

In the present disclosure, when a lubricant is present on the surface of the base material layer 1, the amount of the lubricant present is not limited, but is preferably about 3 mg/m² or more, more preferably about 4 to 15 mg/m², and still more preferably about 5 to 14 mg/m².

In the present disclosure, the lubricant present on the surface of the base material layer 1 may be exuded from the lubricant contained in the resin constituting the base material layer 1, or may be applied to the surface of the base material layer 1.

While the total thickness of the base material layer 1 according to the first aspect is not limited as long as the thickness of the polyester film is in the range of 10 to 14 μm and the thickness of the polyamide film is in the range of 18 to 22 μm, it is preferably about 28 to 50 μm, more preferably about 28 to 40 μm, still more preferably about 30 to 40 μm, even more preferably about 32 to 40 μm, and still more preferably about 32 to 38 μm.

While the total thickness of the base material layer 1 according to the second aspect is not limited as long as the function as a base material is exhibited, it is preferably about 50 μm or less, more preferably about 35 μm or less, and still more preferably about 19 μm or less, while it is preferably about 3 μm or more, and more preferably about 10 μm or more. Preferred ranges include from about 3 to 50 μm, from about 3 to 35 μm, from about 3 to 19 μm, from about 10 to 50 μm, from about 10 to 35 μm, and from about 10 to 19 μm, with the range of about 10 to 19 μm being particularly preferred among the above.

[Coating Layer]

The power storage device packaging material of the present disclosure may optionally include a coating layer (not illustrated) on the base material layer 1 (opposite to the barrier layer 3 side of the base material layer 1), for the purpose of, for example, improving printing characteristics and moldability. The coating layer is formed in surface contact with the base material layer 1. The thickness of the coating layer is not limited as long as the above-described function as a coating layer is exhibited, and is, for example, about 0.01 to 0.40 μm, preferably about 0.01 to 0.30 μm, and more preferably about 0.1 to 0.30 μm. With a thickness of 0.01 μm or more, the coating layer can form a layer with a uniform thickness on the base material layer 1. This can result in uniform printing without unevenness in the printing characteristics on the power storage device packaging material according to the second aspect, and can also result in uniform moldability.

In the present disclosure, examples of the resin forming the coating layer include various synthetic resins, such as polyvinylidene chloride, vinylidene chloride-vinyl chloride copolymer, polyolefins, acid-modified polyolefins, polyesters, epoxy resins, phenol resins, fluororesins, cellulose esters, polyurethanes, acrylic resins, and polyamides. Preferred among the above are polyurethanes, polyesters, and acrylic resins.

In the present disclosure, the coating layer may optionally contain lubricants and additives to improve lubricity. Examples of lubricants are the same lubricants as those mentioned above. Examples of additives are the same additives as those mentioned for the below-described surface coating layer 6. The content and the particle diameter of these lubricants and additives may be adjusted appropriately according to the thickness of the coating layer.

Furthermore, the power storage device packaging material of the present disclosure may optionally include a coating layer (not illustrated) on one surface of the base material layer 1 (the barrier layer 3 side of the base material layer 1 or opposite to the barrier layer 3 of the base material layer 1) or both surfaces of the base material layer 1, for the purpose of improving the adhesiveness to a layer adjacent to the base material layer. That is, the coating layer formed on the base material layer may be a layer intended to improve printing characteristics, moldability, and the like, or may be a layer intended to improve the adhesiveness of the base material layer. Similarly when the coating layer is intended to improve the adhesiveness of the base material layer, examples of the resin forming the coating layer and the thickness of the coating layer are the same as those mentioned above for the resin and the thickness of the coat layer. While the coating layer may contain lubricants or additives as mentioned above, the coating layer preferably does not contain lubricants or additives if there is a layer adjacent to the side of the coating layer opposite to the base material layer.

[Adhesive Agent Layer 2]

In the power storage device packaging material of the present disclosure, the adhesive agent layer 2 is a layer that is optionally provided between the base material layer 1 and the barrier layer 3, for the purpose of improving the adhesiveness between these layers.

In the present disclosure, the adhesive agent layer 2 is formed of an adhesive capable of bonding the base material layer 1 and the barrier layer 3. While the adhesive used for forming the adhesive agent layer 2 is not limited, it may be any of a chemical reaction type, a solvent volatilization type, a heat melting type, a heat pressing type, and the like. The adhesive may also be a two-liquid curable adhesive (two-liquid adhesive), a one-liquid curable adhesive (one-liquid adhesive), or a resin that does not involve a curing reaction. The adhesive agent layer 2 may be composed of a single layer or a plurality of layers.

In the present disclosure, specific examples of adhesive components contained in the adhesive include polyesters, such as polyethylene terephthalate, polybutylene terephthalate, polyethylene naphthalate, polybutylene naphthalate, polyethylene isophthalate, and copolyesters; polyethers; polyurethanes; epoxy resins; phenol resins; polyamides, such as nylon 6, nylon 66, nylon 12, and copolyamides; polyolefin resins, such as polyolefins, cyclic polyolefins, acid-modified polyolefins, and acid-modified cyclic polyolefins; polyvinyl acetates; celluloses; (meth)acrylic resins; polyimides; polycarbonates; amino resins, such as urea resins and melamine resins; rubbers, such as chloroprene rubber, nitrile rubber, and styrene-butadiene rubber; and silicone resins. These adhesive components may be used alone or in combination. Preferred among these adhesive components is a polyurethane adhesive, for example. Moreover, the resin that serves as the adhesive component can be used in combination with an appropriate curing agent to improve the adhesive strength. The curing agent is appropriately selected from a polyisocyanate, a polyfunctional epoxy resin, an oxazoline group-containing polymer, a polyamine resin, an acid anhydride, and the like, according to the functional group of the adhesive component.

In the present disclosure, the polyurethane adhesive may be, for example, a polyurethane adhesive that contains a first agent containing a polyol compound and a second agent containing an isocyanate compound. The polyurethane adhesive is preferably a two-liquid curable polyurethane adhesive containing a polyol such as a polyester polyol, a polyether polyol, or an acrylic polyol as the first agent, and an aromatic or aliphatic polyisocyanate as the second agent. The polyurethane adhesive may also be, for example, a polyurethane adhesive that contains a polyurethane compound obtained by reacting a polyol compound and an isocyanate compound beforehand, and an isocyanate compound. The polyurethane adhesive may also be, for example, a polyurethane adhesive that contains a polyurethane compound obtained by reacting a polyol compound and an isocyanate compound beforehand, and a polyol compound. The polyurethane adhesive may also be, for example, a polyurethane adhesive produced by curing a polyurethane compound obtained by reacting a polyol compound and an isocyanate compound beforehand, by reacting with moisture such as moisture in the air. The polyol compound is preferably a polyester polyol having a hydroxy group at a side chain, in addition to the hydroxy groups at the ends of the repeating unit. Examples of the second agent include aliphatic, alicyclic, aromatic, and aromatic and aliphatic isocyanate compounds. Examples of isocyanate compounds include hexamethylene diisocyanate (HDI), xylylene diisocyanate (XDI), isophorone diisocyanate (IPDI), hydrogenated XDI (H6XDI), hydrogenated MDI (H12MDI), tolylene diisocyanate (TDI), diphenylmethane diisocyanate (MDI), and naphthalene diisocyanate (NDI). Examples also include modified polyfunctional isocyanates obtained from one, or two or more of these diisocyanates. A multimer (for example, a trimer) may also be used as a polyisocyanate compound. Examples of such multimers include adducts, biurets, and isocyanurates. When the adhesive agent layer 2 is formed of a polyurethane adhesive, the power storage device packaging material is provided with excellent electrolytic solution resistance, which prevents the base material layer 1 from delaminating even if the electrolytic solution adheres to the side surface.

In the present disclosure, the adhesive agent layer 2 may be blended with other components as long as they do not interfere with adhesiveness, and may contain colorants, thermoplastic elastomers, tackifiers, fillers, and the like. When the adhesive agent layer 2 contains a colorant, the power storage device packaging material can be colored. The colorant may be any of known colorants, such as a pigment or a dye. A single colorant may be used, or a mixture of two or more colorants may be used.

In the present disclosure, the pigment is not limited in type as long as it does not interfere with the adhesiveness of the adhesive agent layer 2. Examples of organic pigments include azo-based, phthalocyanine-based, quinacridone-based, anthraquinone-based, dioxazine-based, indigo/thioindigo-based, perinone-perylene-based, isoindolenine-based, and benzimidazolone-based pigments. Examples of inorganic pigments include carbon black-based, titanium oxide-based, cadmium-based, lead-based, chromium oxide-based, iron-based, and copper-based pigments. Other examples include mica powder and fish scale flakes.

In the present disclosure, carbon black is preferred among these colorants, in order to make the appearance of the power storage device packaging material black, for example.

In the present disclosure, the average particle diameter of the pigment is not limited, and may be, for example, about 0.05 to 5 μm, and preferably about 0.08 to 2 μm. The average particle diameter of the pigment is the median diameter as measured with a laser diffraction/scattering particle size distribution analyzer.

In the present disclosure, the pigment content in the adhesive agent layer 2 is not limited as long as the power storage device packaging material is colored; for example, it is about 5 to 60% by mass, and preferably 10 to 40% by mass.

In the present disclosure, while the thickness of the adhesive agent layer 2 is not limited as long as the base material layer 1 and the barrier layer 3 can be bonded, it is, for example, about 1 μm or more or about 2 μm or more. On the other hand, the thickness of the adhesive agent layer 2 is, for example, about 10 μm or less or about 5 μm or less. Preferred ranges of the thickness of the adhesive agent layer 2 include from about 1 to 10 μm, from about 1 to 5 μm, from about 2 to 10 μm, and from about 2 to 5 μm.

[Coloring Layer]

In the present disclosure, a coloring layer (not illustrated) is a layer that is optionally provided between the base material layer 1 and the barrier layer 3. When the adhesive agent layer 2 is provided, the coloring layer may be provided between the base material layer 1 and the adhesive agent layer 2 or between the adhesive agent layer 2 and the barrier layer 3. Alternatively, the coloring layer may be provided on the outer side of the base material layer 1. The power storage device packaging material can be colored by providing the coloring layer. The adhesive layer 2 that has been colored and the coloring layer may be provided between the base material layer 1 and the barrier layer 3.

In the present disclosure, the coloring layer can be formed, for example, by applying an ink containing a colorant to the surface of the base material layer 1 or the surface of the barrier layer 3. The colorant may be any of known colorants, such as a pigment or a dye. A single colorant may be used, or a mixture of two or more colorants may be used.

In the present disclosure, specific examples of the colorant contained in the coloring layer are the same as those mentioned in the [Adhesive Agent Layer 2] section.

[Barrier Layer 3]

In the present disclosure, in the power storage device packaging material, the barrier layer 3 is a layer that at least prevents the ingress of moisture.

In the first aspect, the barrier layer 3 may be, for example, a metal foil, a vapor-deposited film, or a resin layer having barrier properties. Examples of the vapor-deposited film include a vapor-deposited metal film, a vapor-deposited inorganic oxide film, and a vapor-deposited carbon-containing inorganic oxide film. Examples of the resin layer include fluorine-containing resins, such as polyvinylidene chloride, polymers containing chlorotrifluoroethylene (CTFE) as a main component, polymers containing tetrafluoroethylene (TFE) as a main component, polymers with fluoroalkyl groups, and polymers with fluoroalkyl units as a main component; and ethylene-vinyl alcohol copolymers. The barrier layer 3 may also be, for example, a resin film having at least one of these vapor-deposited films and resin layers. A plurality of barrier layers 3 may be provided. The barrier layer 3 preferably includes a layer formed of a metal material. Specific examples of the metal material constituting the barrier layer 3 include aluminum alloys, stainless steel, titanium steel, and steel. When the barrier layer 3 is a metal foil, it preferably contains at least one of an aluminum alloy foil and a stainless steel foil.

In the present disclosure, the aluminum alloy foil is more preferably a soft aluminum alloy foil formed of an annealed aluminum alloy, for example, from the viewpoint of improving the moldability of the power storage device packaging material, and is more preferably an aluminum alloy foil containing iron, from the viewpoint of further improving the moldability. In the aluminum alloy foil (100% by mass) containing iron, the iron content is preferably 0.1 to 9.0% by mass, and more preferably 0.5 to 2.0% by mass. When the iron content is 0.1% by mass or more, the power storage device packaging material can be provided with superior moldability. When the iron content is 9.0% by mass or less, the power storage device packaging material can be provided with superior flexibility. Examples of soft aluminum alloy foils include aluminum alloy foils having the compositions as specified in JIS H4160: 1994 A8021 H-O, JIS H4160: 1994 A8079 H-O, JIS H4000: 2014 A8021 P-O, and JIS H4000: 2014 A8079 P-O. These aluminum alloy foils may be optionally blended with silicon, magnesium, copper, manganese, and the like. The softening may be performed by annealing, for example.

In the first aspect, examples of the stainless steel foil include austenitic, ferritic, austenitic-ferritic, martensitic, and precipitation-hardening stainless steel foils. The stainless steel foil is preferably formed of an austenitic stainless steel, from the viewpoint of providing the power storage device packaging material with superior moldability.

In the first aspect, specific examples of the austenitic stainless steel constituting the stainless steel foil include SUS304, SUS301, and SUS316L, with SUS304 being particularly preferred among the above.

In the second aspect, the barrier layer 3 comprises stainless steel. Because the barrier layer 3 comprises stainless steel that is hard and has high damage resistance, the power storage device packaging material 10 can satisfactorily exhibit the effect of the second aspect of the present disclosure. Moreover, because stainless steel is hard and has high damage resistance even when it is made thin, the power storage device packaging material 10 can satisfactorily exhibit the effect of the second aspect of the present disclosure even when the laminate constituting the power storage device packaging material 10 is made thin in thickness. Furthermore, because stainless steel is hard and has high damage resistance, the power storage device packaging material 10 can satisfactorily exhibit the effect of the second aspect of the present disclosure even when the base material layer 1 is made thin. The barrier layer 3 comprises stainless steel, and the polyamide film has a crystallization index of 1.50 or more as measured from an outer side of the base material layer 1, which allows the power storage device packaging material to satisfactorily exhibit the property of having reduced breakage in the power storage device packaging material at the time of separating a power storage device fixed to a casing with a double-sided tape or the like from the casing using a metal spatula or the like, and having reduced damage, such as shape loss and streaks or scratches, due to an impact to the power storage device.

Examples of the stainless steel foil include austenitic, ferritic, austenitic-ferritic, martensitic, and precipitation-hardening stainless steel foils. The stainless steel foil is preferably formed of an austenitic stainless steel, from the viewpoint of more satisfactorily achieving the effect of the second aspect of the present disclosure. Specific examples of the austenitic stainless steel constituting the stainless steel foil include SUS304, SUS301, and SUS316L, with SUS304 being particularly preferred among the above.

In addition to the layer comprising stainless steel (preferably a stainless steel foil), the barrier layer 3 of the second aspect may further include another layer (not comprising stainless steel) that prevents the ingress of moisture. The other layer of the barrier layer 3 may be, for example, a metal foil, a vapor-deposited film, or a resin layer having barrier properties. Examples of the vapor-deposited film include a vapor-deposited metal film, a vapor-deposited inorganic oxide film, and a vapor-deposited carbon-containing inorganic oxide film. Examples of the resin layer include fluorine-containing resins, such as polyvinylidene chloride, polymers containing chlorotrifluoroethylene (CTFE) as a main component, polymers containing tetrafluoroethylene (TFE) as a main component, polymers with fluoroalkyl groups, and polymers with fluoroalkyl units as a main component, and ethylene-vinyl alcohol copolymers. The other layer may also be, for example, a resin film having at least one of these vapor-deposited films and resin layers. A plurality of other layers may be provided. The other layer preferably includes a layer formed of a metal material. Specific examples of the metal material constituting the other layer include aluminum alloys, titanium steel, and steel. When the other layer is a metal foil, it preferably contains an aluminum alloy foil.

In the first aspect, the barrier layer 3 when it is a metal foil may have a thickness sufficient to exhibit at least the function of the barrier layer to prevent the ingress of moisture, and may have a thickness of, for example, about 9 to 200 μm. The thickness of the barrier layer 3 is preferably about 85 μm or less, more preferably about 50 μm or less, and still more preferably about 45 μm or less. On the other hand, the thickness of the barrier layer 3 is preferably about 10 μm or more, more preferably about 20 μm or more, still more preferably about 25 μm or more, even more preferably about 31 μm or more, and still more preferably about 35 μm or more. Preferred ranges of the thickness of the barrier layer 3 include from about 10 to 85 μm, from about 10 to 50 μm, from about 10 to 45 μm, from about 20 to 85 μm, from about 20 to 50 μm, from about 20 to 45 μm, from about 25 to 85 μm, from about 25 to 50 μm, from about 25 to 45 μm, from about 31 to 85 μm, from about 31 to 50 μm, from about 31 to 45 μm, from about 35 to 85 μm, from about 35 to 50 μm, and from about 35 to 45 μm. When the barrier layer 3 is formed of an aluminum alloy foil, the above-defined ranges are particularly preferred. When the barrier layer 3 is formed of an aluminum alloy foil, the thickness of the barrier layer 3 is preferably about 45 μm or more, more preferably about 50 μm or more, and still more preferably about 55 μm or more, while it is preferably about 85 μm or less, more preferably 75 μm or less, and still more preferably 70 μm or less, from the viewpoint of imparting higher moldability and higher rigidity to the power storage device packaging material 10. Preferred ranges include from about 45 to 85 μm, from about 45 to 75 μm, from about 45 to 70 μm, from about 50 to 85 μm, from about 50 to 75 μm, from about 50 to 70 μm, from about 55 to 85 μm, from about 55 to 75 μm, and from about 55 to 70 μm. With higher moldability, the power storage device packaging material 10 becomes easy to deep draw, which can contribute to an increased capacity of the power storage device. Furthermore, when the capacity of the power storage device is increased, the weight of the power storage device increases; however, higher rigidity of the power storage device packaging material 10 can contribute to higher hermeticity of the power storage device. In particular, when the barrier layer 3 is formed of a stainless steel foil, the thickness of the stainless steel foil is preferably about 60 μm or less, more preferably about 50 μm or less, still more preferably about 40 μm or less, even more preferably about 30 μm or less, and particularly preferably about 25 μm or less. On the other hand, the thickness of the stainless steel foil is preferably about 10 μm or more, and more preferably about 15 μm or more. Preferred ranges of the thickness of the stainless steel foil include from about 10 to 60 μm, from about 10 to 50 μm, from about 10 to 40 μm, from about 10 to 30 μm, from about 10 to 25 μm, from about 15 to 60 μm, from about 15 to 50 μm, from about 15 to 40 μm, from about 15 to 30 μm, and from about 15 to 25 μm.

In the second aspect, the barrier layer 3 when it is a metal foil may have a thickness sufficient to exhibit at least the function of the barrier layer to prevent the ingress of moisture, and may have a thickness of, for example, about 9 to 200 μm. The thickness of the barrier layer 3 is preferably about 85 μm or less, more preferably about 50 μm or less, still more preferably about 40 μm or less, even more preferably about 30 μm or less, and particularly preferably about 25 μm or less. On the other hand, the thickness of the barrier layer 3 is preferably about 10 μm or more, and more preferably about 15 μm or more. Preferred ranges of the thickness of the barrier layer 3 include from about 10 to 85 μm, from about 10 to 50 μm, from about 10 to 40 μm, from about 10 to 30 μm, from about 10 to 25 μm, from about 15 to 85 μm, from about 15 to 50 μm, from about 15 to 40 μm, from about 15 to 30 μm, and from about 15 to 25 μm.

In the present disclosure, when the barrier layer 3 is a metal foil, the barrier layer 3 preferably has a corrosion-resistant film at least on a surface opposite to the base material layer, in order to prevent dissolution or corrosion, for example. The barrier layer 3 may have corrosion-resistant films on both surfaces. As used herein, the term “corrosion-resistant film” refers to, for example, a thin film that imparts corrosion resistance (for example, acid resistance and alkali resistance) to the barrier layer, and is formed by subjecting a surface of the barrier layer to, for example, hydrothermal conversion treatment such as boehmite treatment, chemical conversion treatment, anodic oxidation treatment, plating treatment with nickel, chromium, or the like, or anti-corrosion treatment of applying a coating preparation. Specifically, “corrosion-resistant film” means a film for improving the acid resistance of the barrier layer (acid-resistant film), a film for improving the alkali resistance of the barrier layer (alkali-resistant film), and the like. The treatments for forming the corrosion-resistant film may be performed alone or in combination. The corrosion-resistant film may be composed of a plurality of layers instead of a single layer. Among these treatments, the hydrothermal conversion treatment and the anodic oxidation treatment are treatments in which the surface of the metal foil is dissolved with a treatment agent to form a metal compound with excellent corrosion resistance. These treatments may be included in the definition of the chemical conversion treatment. When the barrier layer 3 has a corrosion-resistant film, the corrosion-resistant film is defined as being included in the barrier layer 3.

In the first aspect, the corrosion-resistant film exhibits the effect of preventing delamination between the barrier layer (for example, an aluminum alloy foil) and the base material layer during molding of the power storage device packaging material, preventing dissolution or corrosion of the barrier layer surface, particularly dissolution or corrosion of aluminum oxide present on the barrier layer surface when the barrier layer is an aluminum alloy foil, due to hydrogen fluoride produced by the reaction between the electrolyte and moisture, and improving the adhesiveness (wettability) of the barrier layer surface to prevent delamination between the base material layer and the barrier layer during heat-sealing and prevent delamination between the base material layer and the barrier layer during molding.

In the second aspect, the corrosion-resistant film exhibits the effect of preventing delamination between the barrier layer (a stainless steel foil) and the base material layer during molding of the power storage device packaging material, preventing dissolution or corrosion of the barrier layer surface, particularly dissolution or corrosion of an oxide present on the barrier layer surface when the barrier layer is a stainless steel foil, due to hydrogen fluoride produced by the reaction between the electrolyte and moisture, and improving the adhesiveness (wettability) of the barrier layer surface to prevent delamination between the base material layer and the barrier layer during heat-sealing and prevent delamination between the base material layer and the barrier layer during molding.

In the present disclosure, various corrosion-resistant films formed by the chemical conversion treatment are known, and typical examples include a corrosion-resistant film containing at least one of phosphates, chromates, fluorides, triazine-thiol compounds, and rare earth oxides. Examples of the chemical conversion treatment using phosphates and chromates include chromic acid chromate treatment, phosphoric acid chromate treatment, phosphate-chromate treatment, and chromate treatment. Examples of chromium compounds used in these treatments include chromium nitrate, chromium fluoride, chromium sulfate, chromium acetate, chromium oxalate, chromium biphosphate, acetylacetate chromate, chromium chloride, and chromium potassium sulfate. Examples of phosphorus compounds used in these treatments include sodium phosphate, potassium phosphate, ammonium phosphate, and polyphosphoric acid. Moreover, examples of chromate treatment include etching chromate treatment, electrolytic chromate treatment, and coating-type chromate treatment, with coating-type chromate treatment being preferred. Coating-type chromate treatment is performed as follows: Initially, at least the inner layer-side surface of the barrier layer (for example, an aluminum alloy foil) is subjected to degreasing treatment, using a well-known treatment method such as an alkali immersion method, an electrolytic cleaning method, an acid cleaning method, an electrolytic acid cleaning method, or an acid activation method. Then, a treatment solution containing, as a main component, a phosphoric acid metal salt such as Cr (chromium) phosphate, Ti (titanium) phosphate, Zr (zirconium) phosphate, or Zn (zinc) phosphate, or a mixture of these metal salts, or a treatment solution containing, as a main component, a phosphoric acid non-metal salt or a mixture of such non-metal salts, or a treatment solution containing a mixture of any of the above with a synthetic resin or the like, is applied to the degreasing treatment surface, using a well-known coating method such as a roll coating method, a gravure printing method, or an immersion method, and dried. The treatment solution may be formed using any of various solvents, such as, for example, water, alcohol solvents, hydrocarbon solvents, ketone solvents, ester solvents, and ether solvents, with water being preferred. The resin component to be used here may be, for example, a polymer such as a phenolic resin or an acrylic resin, and chromate treatment using an aminated phenol polymer having any of the repeating units represented by general formulae (1) to (4) shown below may be employed, for example. The aminated phenol polymer may contain one of or any combination of two or more of the repeating units represented by general formulae (1) to (4). The acrylic resin is preferably polyacrylic acid, an acrylic acid-methacrylic acid ester copolymer, an acrylic acid-maleic acid copolymer, an acrylic acid-styrene copolymer, or a derivative thereof, such as a sodium, ammonium, or amine salt. In particular, the acrylic resin is preferably a derivative of polyacrylic acid, such as an ammonium, sodium, or amine salt of polyacrylic acid. As used herein, the term “polyacrylic acid” refers to a polymer of acrylic acid. Alternatively, the acrylic resin is preferably a copolymer of acrylic acid with a dicarboxylic acid or a dicarboxylic anhydride, or preferably an ammonium, sodium, or amine salt of the copolymer of acrylic acid with a dicarboxylic acid or a dicarboxylic anhydride. A single acrylic resin may be used alone, or a mixture of two or more of acrylic resins may be used.

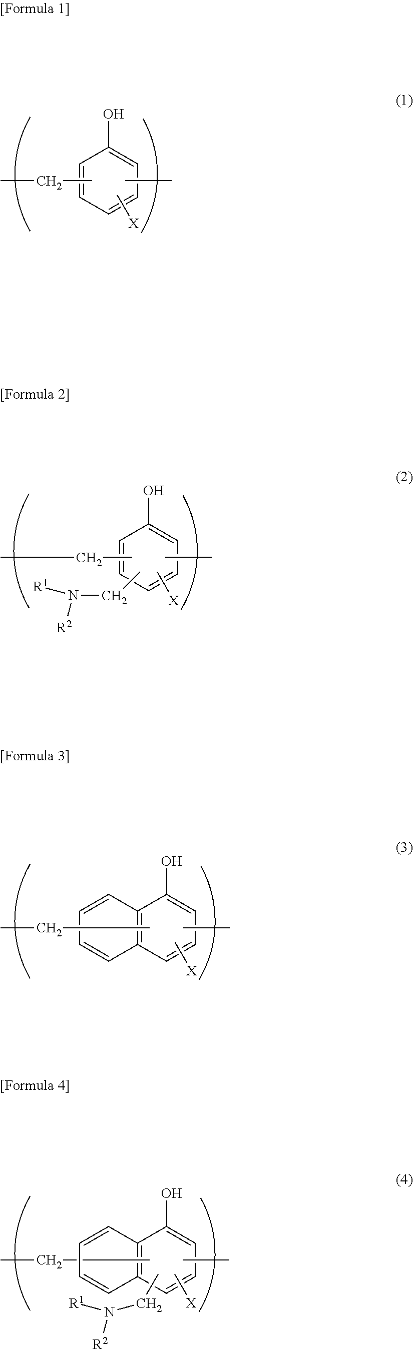

In the present disclosure, in general formulae (1) to (4), X represents a hydrogen atom, a hydroxy group, an alkyl group, a hydroxyalkyl group, an allyl group, or a benzyl group. R¹ and R² are the same or different, and each represent a hydroxy group, an alkyl group, or a hydroxyalkyl group. In general formulae (1) to (4), examples of alkyl groups represented by X, R¹, and R² include linear or branched alkyl groups with 1 to 4 carbon atoms, such as methyl, ethyl, n-propyl, isopropyl, n-butyl, isobutyl, and tert-butyl groups. Examples of hydroxyalkyl groups represented by X, R₁, and R² include linear or branched alkyl groups with 1 to 4 carbon atoms, which are substituted with one hydroxy group, such as a hydroxymethyl, 1-hydroxyethyl, 2-hydroxyethyl, 1-hydroxypropyl, 2-hydroxypropyl, 3-hydroxypropyl, 1-hydroxybutyl, 2-hydroxybutyl, 3-hydroxybutyl, or 4-hydroxybutyl group. In general formulae (1) to (4), the alkyl groups and the hydroxyalkyl groups represented by X, R¹, and R² may be the same or different. In general formulae (1) to (4), X is preferably a hydrogen atom, a hydroxy group, or a hydroxyalkyl group. The number average molecular weight of the aminated phenol polymer having any of the repeating units represented by general formulae (1) to (4) is, for example, about 500 to 1,000,000, preferably about 1,000 to 20,000. The aminated phenol polymer is produced, for example, by polycondensing a phenol compound or a naphthol compound with formaldehyde to produce a polymer composed of the repeating unit represented by general formula (1) or (3) above, and then introducing a functional group (—CH₂NR¹R²) into the polymer obtained above using formaldehyde and an amine (R¹R²NH). A single aminated phenol polymer may be used alone, or a mixture of two or more aminated phenol polymers may be used.

In the present disclosure, other examples of the corrosion-resistant film include a thin film formed by coating-type anti-corrosion treatment in which a coating preparation containing at least one selected from the group consisting of a rare earth element oxide sol, an anionic polymer, and a cationic polymer is applied. The coating preparation may also contain phosphoric acid or a phosphate and a crosslinking agent that crosslinks the polymer. In the rare earth element oxide sol, fine particles of a rare earth element oxide (for example, particles with an average particle diameter of 100 nm or less) are dispersed in a liquid dispersion medium. Examples of the rare earth element oxide include cerium oxide, yttrium oxide, neodymium oxide, and lanthanum oxide, with cerium oxide being preferred from the viewpoint of further improving the adhesion. A single rare earth element oxide or a combination of two or more rare earth element oxides may be contained in the corrosion-resistant film. The liquid dispersion medium of the rare earth element oxide sol may be any of various solvents, such as, for example, water, alcohol solvents, hydrocarbon solvents, ketone solvents, ester solvents, and ether solvents, with water being preferred. Examples of the cationic polymer include polyethyleneimine, ion polymer complexes composed of polymers containing polyethyleneimine and carboxylic acids, primary amine-grafted acrylic resins obtained by grafting primary amines to an acrylic backbone, polyallylamine or derivatives thereof, and aminated phenols. The anionic polymer is preferably a copolymer that contains, as a main component, poly(meth)acrylic acid or a salt thereof, or (meth)acrylic acid or a salt thereof. The crosslinking agent is preferably at least one selected from the group consisting of compounds with any of an isocyanate group, a glycidyl group, a carboxyl group, and an oxazoline group as a functional group, and silane coupling agents. The phosphoric acid or phosphate is preferably condensed phosphoric acid or a condensed phosphate.

In the present disclosure, one exemplary corrosion-resistant film is formed by coating the surface of the barrier layer with a dispersion in phosphoric acid of fine particles of a metal oxide, such as aluminum oxide, titanium oxide, cerium oxide, or tin oxide, or barium sulfate, and baking at 150° C. or more.

In the present disclosure, the corrosion-resistant film may optionally have a laminated structure in which at least one of a cationic polymer and an anionic polymer is additionally laminated. Examples of the cationic polymer and the anionic polymer are those as mentioned above.

In the present disclosure, the composition of the corrosion-resistant film can be analyzed using, for example, time-of-flight secondary ion mass spectrometry.

In the present disclosure, while the amount of the corrosion-resistant film to be formed on the surface of the barrier layer 3 by the chemical conversion treatment is not limited, in the case of employing, for example, coating-type chromate treatment, it is preferred that the chromic acid compound be contained in an amount of about 0.5 to 50 mg, for example, preferably about 1.0 to 40 mg, calculated as chromium, the phosphorus compound be contained in an amount of about 0.5 to 50 mg, for example, preferably about 1.0 to 40 mg, calculated as phosphorus, and the aminated phenol polymer be contained in an amount of about 1.0 to 200 mg, for example, preferably about 5.0 to 150 mg, per m² of the surface of the barrier layer 3.

In the present disclosure, while the thickness of the corrosion-resistant film is not limited, it is preferably about 1 nm to 20 μm, more preferably about 1 to 100 nm, and still more preferably about 1 to 50 nm, from the viewpoint of the cohesive force of the film, and the adhesion force between the barrier layer and the heat-sealable resin layer. The thickness of the corrosion-resistant film can be measured by observation with a transmission electron microscope, or a combination of observation with a transmission electron microscope and energy dispersive X-ray spectroscopy or electron energy loss spectroscopy. As a result of the analysis of the composition of the corrosion-resistant film using time-of-flight secondary ion mass spectrometry, a peak derived from, for example, secondary ions of Ce, P, and O (for example, at least one of Ce₂PO₄⁺, CePO₄⁻, and the like) or a peak derived from, for example, secondary ions of Cr, P, and O (for example, at least one of CrPO₂⁺, CrPO₄⁻, and the like) is detected.

In the present disclosure, the chemical conversion treatment is performed by applying the solution containing the compound to be used for forming the corrosion-resistant film to a surface of the barrier layer, using a bar coating method, a roll coating method, a gravure coating method, an immersion method, or the like, followed by heating such that the temperature of the barrier layer is increased to about 70 to 200° C. Before the barrier layer is subjected to the chemical conversion treatment, the barrier layer may be subjected to the degreasing treatment using an alkali immersion method, an electrolytic cleaning method, an acid cleaning method, an electrolytic acid cleaning method, or the like. The degreasing treatment allows the chemical conversion treatment of the surface of the barrier layer to be more efficiently performed. Alternatively, by using an acid degreasing agent in which a fluorine-containing compound is dissolved in an inorganic acid in the degreasing treatment, it is possible to achieve not only the effect of degreasing the metal foil, but also to form a passive metal fluoride. In this case, only the degreasing treatment may be performed.

[Heat-Sealable Resin Layer 4]

In the power storage device packaging material of the present disclosure, the heat-sealable resin layer 4 corresponds to the innermost layer and is a layer (sealant layer) that is heat-sealed to another heat-sealable resin layer during the assembly of a power storage device to exhibit the function of hermetically sealing the power storage device elements.

In the present disclosure, while the resin constituting the heat-sealable resin layer 4 is not limited as long as it is heat-sealable, examples include resins containing a polyolefin backbone, such as a polyolefin and an acid-modified polyolefin. The inclusion of the polyolefin backbone in the resin constituting the heat-sealable resin layer 4 can be analyzed by, for example, infrared spectroscopy or gas chromatography-mass spectrometry. It is preferred that when the resin constituting the heat-sealable resin layer 4 is analyzed by infrared spectroscopy, a peak derived from maleic anhydride be detected. For example, when a maleic anhydride-modified polyolefin is measured by infrared spectroscopy, peaks derived from maleic anhydride are detected at a wavelength near 1760 cm⁻¹ and a wavelength near 1780 cm⁻¹. When the heat-sealable resin layer 4 is a layer formed of a maleic anhydride-modified polyolefin, the peaks derived from maleic anhydride are detected in infrared spectroscopic measurement. However, if the degree of acid modification is low, the peaks may be so small that they cannot be detected. In that case, the analysis can be performed by nuclear magnetic resonance spectroscopy.

In the present disclosure, specific examples of the polyolefin include polyethylenes, such as low-density polyethylene, medium-density polyethylene, high-density polyethylene, and linear low-density polyethylene; ethylene-α-olefin copolymers; polypropylenes, such as homopolypropylene, block copolymers of polypropylene (for example, block copolymers of propylene and ethylene), and random copolymers of polypropylene (for example, random copolymers of propylene and ethylene); propylene-α-olefin copolymers; and terpolymers of ethylene-butene-propylene. Among the above, polypropylenes are preferred. When the polyolefin resin is a copolymer, it may be a block copolymer or a random copolymer. These polyolefin resins may be used alone or in combination.

In the present disclosure, the polyolefin may also be a cyclic polyolefin. The cyclic polyolefin is a copolymer of an olefin with a cyclic monomer. Examples of the olefin as a constituent monomer of the cyclic polyolefin include ethylene, propylene, 4-methyl-1-pentene, styrene, butadiene, and isoprene. Examples of the cyclic monomer as a constituent monomer of the cyclic polyolefin include cyclic alkenes, such as norbornene; and cyclic dienes, such as cyclopentadiene, dicyclopentadiene, cyclohexadiene, and norbornadiene. Among the above, cyclic alkenes are preferred, and norbornene is more preferred.

In the present disclosure, the acid-modified polyolefin is a polymer obtained by modifying the polyolefin by block polymerization or graft polymerization with an acid component. The polyolefin to be acid-modified may, for example, be the above-mentioned polyolefin, or a copolymer obtained by copolymerizing the above-mentioned polyolefin with a polar molecule, such as acrylic acid or methacrylic acid, or a polymer such as a crosslinked polyolefin. Examples of the acid component to be used for the acid modification include carboxylic acids and anhydrides thereof, such as maleic acid, acrylic acid, itaconic acid, crotonic acid, maleic anhydride, and itaconic anhydride.

In the present disclosure, the acid-modified polyolefin may also be an acid-modified cyclic polyolefin. The acid-modified cyclic polyolefin is a polymer obtained by replacing a portion of the monomers constituting the cyclic polyolefin with an acid component, and copolymerizing them, or by block-polymerizing or graft-polymerizing an acid component onto the cyclic polyolefin. The cyclic polyolefin to be acid-modified is the same as described above. The acid component used for the acid modification is the same as that used for the modification of the above-mentioned polyolefin.

In the present disclosure, examples of preferred acid-modified polyolefins include polyolefins modified with carboxylic acids or anhydrides thereof, polypropylenes modified with carboxylic acids or anhydrides thereof, maleic anhydride-modified polyolefins, and maleic anhydride-modified polypropylenes.

In the present disclosure, the heat-sealable resin layer 4 may be formed of a single resin alone, or may be formed of a blend polymer obtained by combining two or more resins. Furthermore, the heat-sealable resin layer 4 may be formed of only one layer, or may be formed of two or more layers using the same resin or different resins.

In the present disclosure, the heat-sealable resin layer 4 may also optionally contain a lubricant and the like. The inclusion of a lubricant in the heat-sealable resin layer 4 can improve the moldability of the power storage device packaging material. The lubricant is not limited, and may be a known lubricant. Such lubricants may be used alone or in combination.

While the lubricant is not limited, it is preferably an amide-based lubricant. Specific examples of the lubricant are those mentioned for the base material layer 1. Such lubricants may be used alone or in combination.

In the present disclosure, when a lubricant is present on the surface of the heat-sealable resin layer 4, the amount of the lubricant present is not limited, but is preferably about 10 to 50 mg/m², and more preferably about 15 to 40 mg/m², from the viewpoint of improving the moldability of the power storage device packaging material.

In the present disclosure, the lubricant present on the surface of the heat-sealable resin layer 4 may be exuded from the lubricant contained in the resin constituting the heat-sealable resin layer 4, or may be applied to the surface of the heat-sealable resin layer 4.

In the present disclosure, the thickness of the heat-sealable resin layer 4 is not limited as long as the heat-sealable resin layer is heat-sealed to another heat-sealable resin layer to exhibit the function of hermetically sealing the power storage device elements; for example, it is about 100 μm or less, preferably about 85 μm or less, and more preferably about 15 to 85 μm. For example, when the thickness of the below-described adhesive layer 5 is 10 μm or more, the thickness of the heat-sealable resin layer 4 is preferably about 85 μm or less, more preferably about 15 to 45 μm, and still more preferably about 30 to 40 μm. For example, when the thickness of the below-described adhesive layer 5 is less than 10 μm, or when the adhesive layer 5 is not provided, the thickness of the heat-sealable resin layer 4 is preferably about 20 μm or more, and more preferably about 35 to 85 μm.

[Adhesive Layer 5]

In the power storage device packaging material of the present disclosure, the adhesive layer 5 is a layer that is optionally provided between the heat-sealable resin layer 4 and the barrier layer 3 (or the corrosion-resistant film), in order to strongly bond these layers.

In the first aspect, the adhesive layer 5 is formed of a resin capable of bonding the barrier layer 3 and the heat-sealable resin layer 4. Examples of the resin to be used for forming the adhesive layer 5 may include the same adhesives as those mentioned for the adhesive agent layer 2. From the viewpoint of strongly bonding the adhesive layer 5 to the heat-sealable resin layer 4, the resin to be used for forming the adhesive layer 5 preferably contains a polyolefin backbone, and examples of the resin include the polyolefin and the acid-modified polyolefin as mentioned above for the heat-sealable resin layer 4. On the other hand, from the viewpoint of strongly bonding the adhesive layer 5 to the barrier layer 3, the adhesive layer 5 preferably contains an acid-modified polyolefin. Examples of the acid-modification component include dicarboxylic acids, such as maleic acid, itaconic acid, succinic acid, and adipic acid, or anhydrides thereof, acrylic acid, and methacrylic acid, with maleic anhydride being most preferred in view of ease of modification and versatility. From the viewpoint of the heat resistance of the power storage device packaging material, the olefin component is preferably a polypropylene resin, and the adhesive layer 5 most preferably contains a maleic anhydride-modified polypropylene.

In the first aspect, the inclusion of the polyolefin backbone in the resin constituting the adhesive layer 5 can be analyzed by, for example, infrared spectroscopy or gas chromatography-mass spectrometry, although the analytical method is not limited thereto. The inclusion of an acid-modified polyolefin in the resin constituting the adhesive layer 5 can be analyzed, for example, as follows. When, for example, a maleic anhydride-modified polyolefin is measured by infrared spectroscopy, peaks derived from maleic anhydride are detected at a wavelength near 1760 cm⁻¹ and a wavelength near 1780 cm⁻¹. However, if the degree of acid modification is low, the peaks may be so small that they cannot be detected. In that case, the analysis can be performed by nuclear magnetic resonance spectroscopy.

Furthermore, in the first aspect, from the viewpoint of ensuring the durability such as heat resistance and contents resistance of the power storage device packaging material, and also ensuring the moldability while reducing the thickness of the power storage device packaging material, the adhesive layer 5 is more preferably a cured product of a resin composition containing an acid-modified polyolefin and a curing agent. Preferred examples of the acid-modified polyolefin include the same acid-modified polyolefins as those mentioned above.

In the first aspect, preferably, the adhesive layer 5 is a cured product of a resin composition containing an acid-modified polyolefin and at least one selected from the group consisting of a compound having an isocyanate group, a compound having an oxazoline group, and a compound having an epoxy group. Particularly preferably, the adhesive layer 5 is a cured product of a resin composition containing an acid-modified polyolefin and at least one selected from the group consisting of a compound having an isocyanate group and a compound having an epoxy group. The adhesive layer 5 preferably contains at least one selected from the group consisting of a polyurethane, a polyester, and an epoxy resin, and more preferably contains a polyurethane and an epoxy resin. Preferred examples of the polyester include an ester resin produced by reacting an epoxy group and a maleic anhydride group, and an amide ester resin produced by reacting an oxazoline group and a maleic anhydride group. When unreacted matter of the curing agent such as the compound having an isocyanate group, the compound having an oxazoline group, or the epoxy resin remains in the adhesive layer 5, the presence of the unreacted matter can be confirmed using a method selected from, for example, infrared spectroscopy, Raman spectroscopy, and time-of-flight secondary ion mass spectrometry (TOF-SIMS).

In the second aspect, the adhesive layer 5 is formed of a resin capable of bonding the barrier layer 3 and the heat-sealable resin layer 4. Examples of the resin to be used for forming the adhesive layer 5 may include the same adhesives as those mentioned for the adhesive agent layer 2. The resin to be used for forming the adhesive layer 5 preferably contains a polyolefin backbone, and examples of the resin include the polyolefin and the acid-modified polyolefin as mentioned above for the heat-sealable resin layer 4. The inclusion of the polyolefin backbone in the resin constituting the adhesive layer 5 can be analyzed by, for example, infrared spectroscopy or gas chromatography-mass spectrometry, although the analytical method is not limited thereto. It is preferred that when the resin constituting the adhesive layer 5 is analyzed by infrared spectroscopy, a peak derived from maleic anhydride be detected. When, for example, a maleic anhydride-modified polyolefin is measured by infrared spectroscopy, peaks derived from maleic anhydride are detected at a wavelength near 1760 cm⁻¹ and a wavelength near 1780 cm⁻¹. However, if the degree of acid modification is low, the peaks may be so small that they cannot be detected. In that case, the analysis can be performed by nuclear magnetic resonance spectroscopy.

In the second aspect, from the viewpoint of strongly bonding the barrier layer 3 and the heat-sealable resin layer 4, the adhesive layer 5 preferably contains an acid-modified polyolefin. The acid-modified polyolefin is particularly preferably a polyolefin modified with a carboxylic acid or an anhydride thereof, a polypropylene modified with a carboxylic acid or an anhydride thereof, a maleic anhydride-modified polyolefin, or a maleic anhydride-modified polypropylene.

Furthermore, in the second aspect, from the viewpoint of providing the power storage device packaging material with excellent shape stability after molding while reducing the thickness of the power storage device packaging material, the adhesive layer 5 is more preferably a cured product of a resin composition containing an acid-modified polyolefin and a curing agent. Preferred examples of the acid-modified polyolefin include the same acid-modified polyolefins as those mentioned above.

In the second aspect, preferably, the adhesive layer 5 is a cured product of a resin composition containing an acid-modified polyolefin and at least one selected from the group consisting of a compound having an isocyanate group, a compound having an oxazoline group, and a compound having an epoxy group. Particularly preferably, the adhesive layer 5 is a cured product of a resin composition containing an acid-modified polyolefin and at least one selected from the group consisting of a compound having an isocyanate group and a compound having an epoxy group. In the second aspect, the adhesive layer 5 preferably contains at least one selected from the group consisting of a polyurethane, a polyester, and an epoxy resin, and more preferably contains a polyurethane and an epoxy resin. The polyester is preferably an amide ester resin, for example. The amide ester resin is typically produced by reacting a carboxyl group and an oxazoline group. More preferably, the adhesive layer 5 is a cured product of a resin composition containing at least one of these resins and the above-mentioned acid-modified polyolefin. When unreacted matter of the curing agent such as the compound having an isocyanate group, the compound having an oxazoline group, or the epoxy resin remains in the adhesive layer 5, the presence of the unreacted matter can be confirmed using a method selected from, for example, infrared spectroscopy, Raman spectroscopy, and time-of-flight secondary ion mass spectrometry (TOF-SIMS).

In the present disclosure, from the viewpoint of further improving the adhesion between the barrier layer 3 and the adhesive layer 5, the adhesive layer 5 is preferably a cured product of a resin composition containing a curing agent having at least one selected from the group consisting of an oxygen atom, a heterocyclic ring, a C═N bond, and a C—O—C bond. Examples of the curing agent having a heterocyclic ring include a curing agent having an oxazoline group and a curing agent having an epoxy group. Examples of the curing agent having a C═N bond include a curing agent having an oxazoline group and a curing agent having an isocyanate group. Examples of the curing agent having a C—O—C bond include a curing agent having an oxazoline group and a curing agent having an epoxy group. The fact that the adhesive layer 5 is a cured product of a resin composition containing these curing agents can be confirmed using a method such as gas chromatography-mass spectrometry (GCMS), infrared spectroscopy (IR), time-of-flight secondary ion mass spectrometry (TOF-SIMS), or X-ray photoelectron spectroscopy (XPS).

In the present disclosure, while the compound having an isocyanate group is not limited, it is preferably a polyfunctional isocyanate compound, from the viewpoint of effectively improving the adhesion between the barrier layer 3 and the adhesive layer 5. The polyfunctional isocyanate compound is not limited as long as it is a compound having two or more isocyanate groups. Specific examples of polyfunctional isocyanate-based curing agents include pentane diisocyanate (PDI), isophorone diisocyanate (IPDI), hexamethylene diisocyanate (HDI), tolylene diisocyanate (TDI), and diphenylmethane diisocyanate (MDI), as well as polymer or isocyanurate forms thereof, mixtures thereof, or copolymers thereof with other polymers. Examples also include adducts, biurets, and isocyanurates.

The content of the compound having an isocyanate group in the adhesive layer 5 of the present disclosure is preferably in the range of 0.1 to 50% by mass, and more preferably in the range of 0.5 to 40% by mass, in the resin composition constituting the adhesive layer 5. This can effectively improve the adhesion between the barrier layer 3 and the adhesive layer 5.

In the present disclosure, the compound having an oxazoline group is not limited as long as it is a compound having an oxazoline backbone. Specific examples of the compound having an oxazoline group include those having a polystyrene main chain and those having an acrylic main chain. Examples of commercial products include the Epocros series from Nippon Shokubai Co., Ltd.

The content of the compound having an oxazoline group in the adhesive layer 5 of the present disclosure is preferably in the range of 0.1 to 50% by mass, and more preferably in the range of 0.5 to 40% by mass, in the resin composition constituting the adhesive layer 5. This can effectively improve the adhesion between the barrier layer 3 and the adhesive layer 5.

In the present disclosure, examples of the compound having an epoxy group include an epoxy resin. The epoxy resin is not limited as long as it is a resin capable of forming a crosslinked structure with an epoxy group present in the molecule, and may be any of known epoxy resins. The weight average molecular weight of the epoxy resin is preferably about 50 to 2,000, more preferably about 100 to 1,000, and still more preferably about 200 to 800. In the first aspect of the disclosure, the weight average molecular weight of the epoxy resin is the value as measured by gel permeation chromatography (GPC), measured under conditions using polystyrene as standard samples.

In the present disclosure, specific examples of the epoxy resin include glycidyl ether derivative of trimethylolpropane, bisphenol A diglycidyl ether, modified bisphenol A diglycidyl ether, bisphenol F-type glycidyl ether, novolac glycidyl ether, glycerol polyglycidyl ether, and polyglycerol polyglycidyl ether. These epoxy resins may be used alone or in combination.

The content of the epoxy resin in the adhesive layer 5 of the present disclosure is preferably in the range of 0.1 to 50% by mass, and more preferably in the range of 0.5 to 40% by mass, in the resin composition constituting the adhesive layer 5. This can effectively improve the adhesion between the barrier layer 3 and the adhesive layer 5.

In the present disclosure, the polyurethane is not limited, and may be any of known polyurethanes. The adhesive layer 5 may be, for example, a cured product of a two-liquid curable polyurethane.

The content of the polyurethane in the adhesive layer 5 of the present disclosure is preferably in the range of 0.1 to 50% by mass, and more preferably in the range of 0.5 to 40% by mass, in the resin composition constituting the adhesive layer 5. This can effectively improve the adhesion between the barrier layer 3 and the adhesive layer 5, in an atmosphere containing a component that induces corrosion of the barrier layer, such as an electrolytic solution.

In the present disclosure, when the adhesive layer 5 is a cured product of a resin composition containing the above-mentioned acid-modified polyolefin and at least one selected from the group consisting of a compound having an isocyanate group, a compound having an oxazoline group, and an epoxy resin, the acid-modified polyolefin functions as a base resin, and each of the compound having an isocyanate group, the compound having an oxazoline group, and the compound having an epoxy group functions as a curing agent.

In the present disclosure, the adhesive layer 5 may contain a modifier having a carbodiimide group.

The thickness of the adhesive layer 5 of the first aspect is preferably about 50 μm or less, about 40 μm or less, about 30 μm or less, about 20 μm or less, or about 5 μm or less. On the other hand, the thickness of the adhesive layer 5 is preferably about 0.1 μm or more, about 0.5 μm or more, about 10 μm or more, or about 30 μm or more. Preferred ranges of the thickness of the adhesive layer 5 include from about 0.1 to 50 μm, from about 0.1 to 40 μm, from about 0.1 to 30 μm, from about 0.1 to 20 μm, from about 0.1 to 5 μm, from about 0.5 to 50 μm, from about 0.5 to 40 μm, from about 0.5 to 30 μm, from about 0.5 to 20 μm, from about 0.5 to 5 μm, from about 10 to 50 μm, from about 10 to 40 μm, from about 10 to 30 μm, from about 10 to 20 μm, from about 30 to 50 μm, and from about 30 to 40 μm. More specifically, when the adhesive layer 5 is an adhesive as mentioned for the adhesive agent layer 2 or a cured product of an acid-modified polyolefin and a curing agent, the thickness of the adhesive layer 5 is preferably about 1 to 10 μm, and more preferably about 1 to 5 μm. When the adhesive layer 5 is formed of a resin as mentioned for the heat-sealable resin layer 4, the thickness of the adhesive layer 5 is preferably about 2 to 50 μm, more preferably about 10 to 40 μm, and still more preferably about 30 to 40 μm. When the adhesive layer 5 is an adhesive as mentioned for the adhesive agent layer 2 or a cured product of a resin composition containing an acid-modified polyolefin and a curing agent, the adhesive layer 5 can be formed by, for example, applying the resin composition, and curing by heating or the like. When the adhesive layer 5 is formed of a resin as mentioned for the heat-sealable resin layer 4, the adhesive layer 5 can be formed by, for example, extrusion molding of the heat-sealable resin layer 4 and the adhesive layer 5.

The upper limit of the thickness of the adhesive layer 5 of the second aspect is preferably about 50 μm or less, about 40 μm or less, about 30 μm or less, about 20 μm or less, or about 5 μm or less, while the lower limit is preferably about 0.1 μm or more or about 0.5 μm or more. Preferred ranges of the thickness include from about 0.1 to 50 μm, from about 0.1 to 40 μm, from about 0.1 to 30 μm, from about 0.1 to 20 μm, from about 0.1 to 5 μm, from about 0.5 to 50 μm, from about 0.5 to 40 μm, from about 0.5 to 30 μm, from about 0.5 to 20 μm, and from about 0.5 to 5 μm. More specifically, when the adhesive layer 5 is an adhesive as mentioned for the adhesive agent layer 2 or a cured product of an acid-modified polyolefin and a curing agent, the thickness of the adhesive layer 5 is preferably about 1 to 10 μm, and more preferably about 1 to 5 μm. When the adhesive layer 5 is formed of a resin as mentioned for the heat-sealable resin layer 4, the thickness of the adhesive layer 5 is preferably about 2 to 50 μm, and more preferably about 10 to 40 μm. When the adhesive layer 5 is an adhesive as mentioned for the adhesive agent layer 2 or a cured product of a resin composition containing an acid-modified polyolefin and a curing agent, the adhesive layer 5 can be formed by, for example, applying the resin composition, and curing by heating or the like. When the adhesive layer 5 is formed of a resin as mentioned for the heat-sealable resin layer 4, the adhesive layer 5 can be formed by, for example, extrusion molding of the heat-sealable resin layer 4 and the adhesive layer 5.

[Surface Coating Layer 6]

The power storage device packaging material according to the first aspect may optionally include a surface coating layer 6 on the base material layer 1 (opposite to the barrier layer 3 on the base material layer 1) for at least one of the purposes of improving the designability, electrolytic solution resistance, scratch resistance, and moldability, for example. The surface coating layer 6 is a layer positioned as the outermost layer of the power storage device packaging material when a power storage device is assembled using the power storage device packaging material.

The surface coating layer 6 of the first aspect may be formed of a resin such as polyvinylidene chloride, a polyester, a polyurethane, an acrylic resin, or an epoxy resin, for example.

When the resin forming the surface coating layer 6 of the first aspect is a curable resin, the resin may be either a one-liquid curable resin or a two-liquid curable resin, preferably a two-liquid curable resin. The two-liquid curable resin may be, for example, a two-liquid curable polyurethane, a two-liquid curable polyester, or a two-liquid curable epoxy resin. Among the above, a two-liquid curable polyurethane is preferred.

In the first aspect, the two-liquid curable polyurethane may be, for example, a polyurethane that contains a first agent containing a polyol compound and a second agent containing an isocyanate compound. The two-liquid curable polyurethane is preferably a two-liquid curable polyurethane that contains a polyol such as a polyester polyol, a polyether polyol, or an acrylic polyol as the first agent, and an aromatic or aliphatic polyisocyanate as the second agent. The polyurethane may be, for example, a polyurethane that contains a polyurethane compound obtained by reacting a polyol compound and an isocyanate compound beforehand, and an isocyanate compound. The polyurethane may be, for example, a polyurethane that contains a polyurethane compound obtained by reacting a polyol compound and an isocyanate compound beforehand, and a polyol compound. The polyurethane may be, for example, a polyurethane produced by curing a polyurethane compound obtained by reacting a polyol compound and an isocyanate compound beforehand, by reacting with moisture such as moisture in the air. The polyol compound is preferably a polyester polyol having a hydroxy group at a side chain, in addition to the hydroxy groups at the ends of the repeating unit. Examples of the second agent include aliphatic, alicyclic, aromatic, and aromatic and aliphatic isocyanate compounds. Examples of isocyanate compounds include hexamethylene diisocyanate (HDI), xylylene diisocyanate (XDI), isophorone diisocyanate (IPDI), hydrogenated XDI (H6XDI), hydrogenated MDI (H12MDI), tolylene diisocyanate (TDI), diphenylmethane diisocyanate (MDI), and naphthalene diisocyanate (NDI). Examples also include modified polyfunctional isocyanates obtained from one, or two or more of these diisocyanates. A multimer (for example, a trimer) may also be used as a polyisocyanate compound. Examples of such multimers include adducts, biurets, and isocyanurates. An aliphatic isocyanate compound refers to an isocyanate having an aliphatic group and no aromatic ring, an alicyclic isocyanate compound refers to an isocyanate having an alicyclic hydrocarbon group, and an aromatic isocyanate compound refers to an isocyanate having an aromatic ring. When the surface coating layer 6 is formed of a polyurethane, the power storage device packaging material is imparted with excellent electrolytic solution resistance.

In the first aspect, at least one of a surface and an inside of the surface coating layer 6 may optionally contain additives, such as the above-mentioned lubricants, anti-blocking agents, matting agents, flame retardants, antioxidants, tackifiers, and anti-static agents, according to the functionality and the like to be imparted to the surface coating layer 6 and the surface thereof. Examples of the additives include fine particles having an average particle diameter of about 0.5 nm to 5 μm. The average particle diameter of the additives is the median diameter as measured using a laser diffraction/scattering particle size distribution analyzer.

The power storage device packaging material according to the second aspect may optionally include a surface coating layer 6 on the base material layer 1 (opposite to the barrier layer 3 on the base material layer 1) for at least one of the purposes of improving the designability, electrolytic solution resistance, scratch resistance, and moldability, for example. The surface coating layer 6 is a layer positioned as the outermost layer of the power storage device packaging material when a power storage device is assembled using the power storage device packaging material. When the power storage device packaging material 10 includes the surface coating layer, the power storage device packaging material 10 can satisfactorily exhibit a superior effect in that the entire surface coating layer is protected from the outside, breakage or damage in the power storage device packaging material can be more satisfactorily reduced, and the power storage device packaging material is resistant to damage in a high-temperature environment.

In the second aspect, the surface coating layer 6 may be formed of, for example, a resin such as polyvinylidene chloride, a polyester, a polyamide, an epoxy resin, an acrylic resin, a fluororesin, a polyurethane, a silicone resin, a phenol resin, or a modified resin thereof. The resin may also be a copolymer of these resins or a modified copolymer thereof. The resin may also be a mixture of these resins. The resin is preferably a curable resin. That is, the surface coating layer 6 is preferably formed of a cured product of a resin composition containing a curable resin.

In the second aspect, when the resin forming the surface coating layer 6 is a curable resin, the resin may be either a one-liquid curable resin or a two-liquid curable resin, preferably a two-liquid curable resin. The two-liquid curable resin may be, for example, a two-liquid curable polyurethane, a two-liquid curable polyester, or a two-liquid curable epoxy resin. Among the above, a two-liquid curable polyurethane is preferred.

In the second aspect, the two-liquid curable polyurethane may be, for example, a polyurethane that contains a base resin containing a polyol compound and a curing agent containing an isocyanate compound. The two-liquid curable polyurethane is preferably a two-liquid curable polyurethane that contains a polyol such as a polyester polyol, a polyether polyol, or an acrylic polyol as the base resin, and an aromatic or aliphatic polyisocyanate as the curing agent. The polyol compound is preferably a polyester polyol having a hydroxy group at a side chain, in addition to the hydroxy groups at the ends of the repeating unit. When the surface coating layer 6 is formed of a polyurethane, the power storage device packaging material is imparted with excellent electrolytic solution resistance.

In the second aspect, at least one of a surface and an inside of the surface coating layer 6 may optionally contain additives, such as the above-mentioned lubricants, anti-blocking agents, matting agents, flame retardants, antioxidants, tackifiers, and anti-static agents, according to the functionality and the like to be imparted to the surface coating layer 6 and the surface thereof. Examples of the additives include fine particles having an average particle diameter of about 0.5 nm to 5 μm. The average particle diameter of the additives is the median diameter as measured using a laser diffraction/scattering particle size distribution analyzer.

In the present disclosure, the additives may be either inorganic or organic. The additives are also not limited in shape, and may be spherical, fibrous, plate-like, irregular, or flake-like, for example.

In the present disclosure, specific examples of the additives include talc, silica, graphite, kaolin, montmorillonite, mica, hydrotalcite, silica gel, zeolite, aluminum hydroxide, magnesium hydroxide, zinc oxide, magnesium oxide, aluminum oxide, neodymium oxide, antimony oxide, titanium oxide, cerium oxide, calcium sulfate, barium sulfate, calcium carbonate, calcium silicate, lithium carbonate, calcium benzoate, calcium oxalate, magnesium stearate, alumina, carbon black, carbon nanotubes, high-melting-point nylons, acrylate resins, crosslinked acrylic, crosslinked styrene, crosslinked polyethylene, benzoguanamine, gold, aluminum, copper, and nickel. These additives may be used alone or in combination. Among these additives, silica, barium sulfate, and titanium oxide are preferred from the viewpoint of dispersion stability, costs, and the like. Surfaces of the additives may be subjected to various types of surface treatment, such as insulation treatment and dispersibility enhancing treatment.

In the present disclosure, examples of methods of forming the surface coating layer 6 include, but are not limited to, applying the resin for forming the surface coating layer 6. When an additive is to be used in the surface coating layer 6, the resin blended with the additive may be applied.

In the present disclosure, the thickness of the surface coating layer 6 is not limited as long as the above-described function as the surface coating layer 6 is exhibited; for example, it is about 0.5 to 10 μm, and preferably about 1 to 5 μm.

3. Method for Producing Power Storage Device Packaging Material

The method for producing the power storage device packaging material according to the first aspect is not limited as long as it produces a laminate in which the layers of the power storage device packaging material according to the first aspect are laminated, and may be a method comprising the step of providing a laminate in which at least a base material layer, a barrier layer, and a heat-sealable resin layer are laminated sequentially from an outer side, wherein the base material layer comprises a polyester film and a polyamide film, the polyester film has a thickness of 10 μm or more and 14 μm or less, and the polyamide film has a thickness of 18 μm or more and 22 μm or less.

The method for producing the power storage device packaging material according to the second aspect is not limited as long as it produces a laminate in which the layers of the power storage device packaging material according to the second aspect are laminated, and may, for example, be a method comprising the step of laminating at least the base material layer 1, the barrier layer 3, and the heat-sealable resin layer 4 sequentially from an outer side. Specifically, the method for producing the power storage device packaging material according to the second aspect comprises the step of providing a laminate in which at least a base material layer, a barrier layer, and a heat-sealable resin layer are laminated sequentially from an outer side, wherein the base material layer comprises a polyamide film, the barrier layer 3 comprises stainless steel, and the polyamide film has a crystallization index of 1.50 or more as measured from an outer side of the base material layer by Fourier transform infrared spectroscopy using ATR.

One example of the method for producing the power storage device packaging material of the present disclosure is as follows: Initially, a laminate including the base material layer 1, the adhesive agent layer 2, and the barrier layer 3 in this order (the laminate may be hereinafter denoted as the “laminate A”) is formed. Specifically, the laminate A can be formed using a dry lamination method as follows: The adhesive to be used for forming the adhesive agent layer 2 is applied to the base material layer 1 or to the barrier layer 3 with surface(s) optionally subjected to chemical conversion treatment, using a coating method such as a gravure coating method or a roll coating method, and dried. Then, the barrier layer 3 or the base material layer 1 is laminated thereon, and the adhesive agent layer 2 is cured.

Subsequently, the heat-sealable resin layer 4 is laminated on the barrier layer 3 of the laminate A. When the heat-sealable resin layer 4 is to be laminated directly on the barrier layer 3, the heat-sealable resin layer 4 may be laminated onto the barrier layer 3 of the laminate A, using a method such as a thermal lamination method or an extrusion lamination method. When the adhesive layer 5 is to be provided between the barrier layer 3 and the heat-sealable resin layer 4, exemplary methods include the following: (1) a method in which the adhesive layer 5 and the heat-sealable resin layer 4 are extruded to be laminated on the barrier layer 3 of the laminate A (co-extrusion lamination or tandem lamination method); (2) a method in which a laminate in which the adhesive layer 5 and the heat-sealable resin layer 4 are laminated is separately formed, and this laminate is laminated on the barrier layer 3 of the laminate A using a thermal lamination method, or a method in which a laminate in which the adhesive layer 5 is laminated on the barrier layer 3 of the laminate A is formed, and this laminate is laminated to the heat-sealable resin layer 4 using a thermal lamination method; (3) a method in which the adhesive layer 5 that has been melted is poured between the barrier layer 3 of the laminate A and the heat-sealable resin layer 4 pre-formed into a sheet, and simultaneously the laminate A and the heat-sealable resin layer 4 are bonded with the adhesive layer 5 sandwiched therebetween (sandwich lamination method); and (4) a method in which the adhesive for forming the adhesive layer 5 is laminated on the barrier layer 3 of the laminate A by, for example, applying the adhesive onto the barrier layer 3 using solution coating, and drying, or further baking, and then the heat-sealable resin layer 4 pre-formed into a sheet is laminated on the adhesive layer 5.

Next, in the first aspect, the surface coating layer 6 is optionally laminated on the surface of the base material layer 1 opposite to the barrier layer 3. The surface coating layer 6 can be formed by, for example, applying the above-mentioned resin composition forming the surface coating layer 6 onto the surface of the base material layer 1 and curing. In the first aspect, the order of the step of laminating the barrier layer 3 on the surface of the base material layer 1 and the step of laminating the surface coating layer 6 on the surface of the base material layer 1 is not limited. For example, the surface coating layer 6 may be formed on the surface of the base material layer 1, and then the barrier layer 3 may be formed on the surface of the base material layer 1 opposite to the surface coating layer 6.

In the second aspect, when the surface coating layer 6 is to be provided, the surface coating layer 6 is laminated on the surface of the base material layer 1 opposite to the barrier layer 3. The surface coating layer 6 can be formed by, for example, applying the above-mentioned resin forming the surface coating layer 6 onto the surface of the base material layer 1. The order of the step of laminating the barrier layer 3 on the surface of the base material layer 1 and the step of laminating the surface coating layer 6 on the surface of the base material layer 1 is not limited. For example, the surface coating layer 6 may be formed on the surface of the base material layer 1, and then the barrier layer 3 may be formed on the surface of the base material layer 1 opposite to the surface coating layer 6.

In the present disclosure, the foregoing procedure gives a laminate including, sequentially from the outer side, the optional surface coating layer 6/the base material layer 1/the optional adhesive agent layer 2/the barrier layer 3/the optional adhesive layer 5/the heat-sealable resin layer 4. The laminate may optionally be further subjected to heat treatment, in order to strengthen the adhesiveness of the optional adhesive agent layer 2 and the optional adhesive layer 5. Moreover, as described above, a coloring layer may be provided between the base material layer 1 and the barrier layer 3.

In the power storage device packaging material of the present disclosure, each layer constituting the laminate may be optionally subjected to a surface activation treatment, such as corona treatment, blast treatment, oxidation treatment, or ozone treatment, to thereby improve the processability. For example, ink printability on the surface of the base material layer 1 can be improved by corona-treating the surface of the base material layer 1 opposite to the barrier layer 3.

4. Uses of Power Storage Device Packaging Material

The power storage device packaging material of the present disclosure is used as a package for hermetically sealing and housing a power storage device element including a positive electrode, a negative electrode, and an electrolyte. That is, a power storage device can be provided by housing a power storage device element comprising at least a positive electrode, a negative electrode, and an electrolyte in a package formed of the power storage device packaging material of the present disclosure.

Specifically, a power storage device element comprising at least a positive electrode, a negative electrode, and an electrolyte is covered with the power storage device packaging material of the present disclosure such that a flange portion (region where the heat-sealable resin layer is contacted with another heat-sealable resin layer) can be formed on the periphery of the power storage device element, with the metal terminal connected to each of the positive electrode and the negative electrode protruding to the outside. Then, the heat-sealable resin layers in the flange portion are heat-sealed to hermetically seal the power storage device element. As a result, a power storage device is provided using the power storage device packaging material. When the power storage device element is housed in the package formed of the power storage device packaging material of the present disclosure, the package is formed such that the heat-sealable resin layer portion of the power storage device packaging material of the present disclosure is positioned on the inner side (surface in contact with the power storage device element). Two sheets of the power storage device packaging material may be overlaid with each other with the heat-sealable resin layers opposing each other, and peripheral portions of the power storage device packaging materials overlaid with each other may be heat-sealed to form a package. Alternatively, as in the example shown in FIG. 5, one sheet of the power storage device packaging material may be folded over to overlay one surface with the other, and peripheral portions thereof may be heat-sealed to form a package. When the power storage device packaging material is folded over to overlay one surface with the other, the sides other than the folded sides may be heat-sealed to form a package by three-side sealing, as in the example shown in FIG. 5. Alternatively, the power storage device packaging material may be folded over such that a flange portion is formed, and a package may be formed by four-side sealing. Moreover, in the power storage device packaging material, a concave portion for housing the power storage device element may be formed by deep drawing or bulging. As in the example shown in FIG. 5, a concave portion may be provided in one sheet of the power storage device packaging material, but not in the other sheet. Alternatively, a concave portion may also be provided in the other sheet of the power storage device packaging material.

The power storage device packaging material of the present disclosure is suitable for use in power storage devices, such as batteries (including condensers and capacitors). The power storage device packaging material of the present disclosure may be used for either primary batteries or secondary batteries, but are preferably used for secondary batteries. While the type of secondary batteries to which the power storage device packaging material of the present disclosure is applied is not limited, examples include lithium ion batteries, lithium ion polymer batteries, all-solid-state batteries, lead storage batteries, nickel-hydrogen storage batteries, nickel-cadmium storage batteries, nickel-iron storage batteries, nickel-zinc storage batteries, silver oxide-zinc storage batteries, metal-air batteries, polyvalent cation batteries, condensers, and capacitors. Among these secondary batteries, preferred secondary batteries to which the power storage device packaging material of the present disclosure is applied include lithium ion batteries and lithium ion polymer batteries.

Typically, a power storage device is fixed to the casing of any of various products with a double-sided tape or an adhesive. That is, the power storage device packaging material 10 according to the second aspect is fixed to the casing of any of various products with a double-sided tape or an adhesive. The material of the casing may vary widely depending on the type of product, including, for example, metals such as stainless steel, aluminum alloy, and nickel alloy, plastics such as polyolefins, polyamides, polyesters, polyimides, and polystyrenes, and glass.

The adhesive strength between the power storage device and the casing is adjusted to a degree such that, for example, the power storage device can be separated from the casing. For example, the power storage device is preferably fixed to the casing using a double-sided tape that can give a peeling strength with respect to a stainless steel plate of about 5 to 15 N/7.5 mm as measured in (Measurement of Peeling Strength of Double-Sided Tape) described below. The power storage device packaging material 10 according to the second aspect is suitable for use with a power storage device fixed to a casing with a double-sided tape that can give a peeling strength with respect to the casing of about 5 to 15 N/7.5 mm.

5. Polyamide Film

The polyamide film according to the second aspect is a polyamide film for use as a base material layer in a power storage device packaging material comprising a laminate comprising at least the base material layer, a barrier layer, and a heat-sealable resin layer, wherein the barrier layer comprises stainless steel, and the polyamide film has a crystallization index of 1.50 or more as measured by Fourier transform infrared spectroscopy using ATR. The details of the power storage device packaging material 10 according to the second aspect are as described above.

By using the polyamide film according to the second aspect as the base material layer 1 of the power storage device packaging material, the crystallization index of the polyamide film of the base material layer 1 of the power storage device packaging material 10 can be satisfactorily adjusted to 1.50 or more, and breakage in the power storage device packaging material can be effectively reduced at the time of separation as described above. That is, the power storage device packaging material 10 according to the second aspect is preferably produced by using, as the base material layer 1, the polyamide film according to the second aspect in which the crystallization index has been previously adjusted to 1.50 or more, and laminating the polyamide film with a layer such as the barrier layer 3 or the heat-sealable resin layer 4. As described above, the crystallization index of the polyamide film contained in the base material layer 1 after being laminated on the power storage device packaging material 10 can be increased more than the crystallization index of the polyamide film before being applied to the power storage device packaging material 10. Specifically, in the production process of the power storage device packaging material 10, heat may be applied to the polyamide film to increase the crystallization index.

The method of measuring the crystallization index of the polyamide film according to the second aspect is as follows.

<Measurement of Crystallization Index of Polyamide Film>

The polyamide film is cut into a 100 mm×100 mm square to prepare a sample. The surface of the resulting sample is subjected to infrared absorption spectrum measurement in an environment at a temperature of 25° C. and a relative humidity of 50%, using the ATR measurement mode of FT-IR. For example, Nicolet iS10 from Thermo Fisher Scientific Co., Ltd. may be used as the apparatus. From the obtained absorption spectrum, the peak intensity P near 1200 cm⁻¹ due to the absorption of the α-crystal of nylon and the peak intensity Q near 1370 cm⁻¹ due to absorption not associated with the crystal are measured, and the intensity ratio of the peak intensity P to the peak intensity Q, X=P/Q, is calculated as the crystallization index.
(Measurement Conditions)
Method: Macro ATR
Wavenumber resolution: 8 cm⁻¹
Accumulation times: 32
Detector: DTGS detector
ATR prism: Ge
Incident angle: 45°
Baseline: The baseline is obtained by connecting two points, i.e., the first valley on the low wavenumber side of the absorption peak intensity Y₁₂₀₀ and the first valley on the high wavenumber side of the absorption peak intensity Y₁₃₇₀, with a straight line. See the schematic diagram in FIG. 8. In FIG. 8, the right side of the horizontal axis (WAVENUMBER) corresponds to the low wavelength side, and the left side of the horizontal axis (WAVENUMBER) corresponds to the high wavelength side. The position indicated by M is “the first valley on the low wavenumber side of the absorption peak intensity Y₁₂₀₀”, and the position indicated by N is “the first valley on the high wavenumber side of the absorption peak intensity Y₁₃₇₀”.
Absorption peak intensity Y₁₂₀₀: a value obtained by subtracting the baseline value from the maximum value of peak intensity in the wavenumber range of 1195 cm⁻¹ to 1205 cm⁻¹
Absorption peak intensity Y₁₃₇₀: a value obtained by subtracting the baseline value from the maximum value of peak intensity in the wavenumber range of 1365 cm⁻¹ to 1375 cm⁻¹
The crystallization index of the polyamide film according to the second aspect may be any value in the range of 1.50 or more; however, it is more preferably 1.55 or more, still more preferably 1.60 or more, and particularly preferably 1.65 or more, from the viewpoint of more effectively reducing breakage in the power storage device packaging material at the time of separation as described above. While the upper limit of the crystallization index is not limited, it is, for example, 2.50 or less, or 1.80 or less. Preferred ranges of the crystallization index include, for example, from 1.50 to 2.50, from 1.55 to 2.50, from 1.60 to 2.50, from 1.65 to 2.50, from 1.50 to 1.80, from 1.55 to 1.80, from 1.60 to 1.80, and from 1.65 to 1.80.

In the second aspect, specific examples of the polyamide forming the polyamide film are as mentioned above in the section regarding the base material layer 1 of the power storage device packaging material 10. The polyamide film may be an unstretched film or a stretched film. The stretched film is, for example, a uniaxially stretched film or a biaxially stretched film, preferably a biaxially stretched film. Examples of stretching methods for forming a biaxially stretched film include a sequential biaxial stretching method, an inflation method, and a simultaneous biaxial stretching method. Examples of methods of applying the resin include a roll coating method, a gravure coating method, and an extrusion coating method.

In the second aspect, the polyamide film is particularly preferably a biaxially stretched nylon film.

In the second aspect, from the viewpoint of more effectively reducing breakage in the power storage device packaging material at the time of separation as described above, the thickness of the polyamide film is preferably about 3 μm or more, and more preferably about 10 μm or more, while it is preferably about 50 μm or less, and more preferably about 35 μm or less. Preferred ranges include from about 3 to 50 μm, from about 3 to 35 μm, from about 10 to 50 μm, and from about 10 to 35 μm. The range of about 10 to 35 μm is particularly preferred among the above.

In the second aspect, at least one of a surface and an inside of the polyamide film may contain additives, such as lubricants, flame retardants, anti-blocking agents, antioxidants, light stabilizers, tackifiers, and anti-static agents. A single additive may be used alone, or a mixture of two or more additives may be used. The details of the additives are as described above in the section regarding the base material layer 1 of the power storage device packaging material 10.

### EXAMPLES

The present disclosure will be hereinafter described in detail with reference to examples and comparative examples, although the present disclosure is not limited to the examples.

<Production of Power Storage Device Packaging Materials According to First Aspect>

### Examples 1A, 2A and 5A-8A, and Comparative Examples 1A-9A

As a base material layer, a polyethylene terephthalate (PET) film (thickness: 12 μm) and a stretched nylon (ONy) film (each having a thickness and a crystallization index as shown in Table 1 A) were prepared. A two-liquid urethane adhesive (a polyol compound and an aromatic isocyanate compound) was used to bond the PET film and the ONy film via the adhesive agent layer such that the thickness of the adhesive agent layer after curing was 3 μm. As a barrier layer, an aluminum foil (JIS H4160: 1994 A8021H-O (each having a thickness as shown in Table 1A (35 or 40 μm)) was prepared. Next, a two-liquid urethane adhesive (a polyol compound and an aromatic isocyanate compound) was used to laminate the aluminum foil and the base material layer (ONy film side) using a dry lamination method such that the thickness of the adhesive agent layer after curing was 3 μm, and the resulting laminate was subjected to aging treatment to prepare a laminate of the base material layer/the adhesive agent layer/the barrier layer. Both surfaces of the aluminum foil had been subjected to chemical conversion treatment. The chemical conversion treatment of the aluminum foil was performed by applying a treatment solution containing a phenol resin, a chromium fluoride compound, and phosphoric acid to both surfaces of the aluminum foil using a roll coating method such that the amount of chromium applied was 10 mg/m² (dry mass), and baking.

Next, an adhesive layer and a heat-sealable resin layer were laminated on the barrier layer of each laminate obtained above. Specifically, a maleic anhydride-modified polypropylene as the adhesive layer and a random polypropylene as the heat-sealable resin layer were melt co-extruded such that each layer had a thickness as shown in Table 1A, to laminate the adhesive layer/the heat-sealable resin layer on the barrier layer. This resulted in a power storage device packaging material sequentially having the base material layer/the adhesive agent layer/the barrier layer/the adhesive layer/the heat-sealable resin layer.

### Examples 3A and 4A

A laminate of the base material layer/the adhesive agent layer/the barrier layer was produced as in Examples 5A and 6A. Next, an adhesive layer and a heat-sealable resin layer were laminated on the barrier layer of each resulting laminate. Specifically, a two-liquid curable adhesive (an acid-modified polypropylene and an epoxy compound) was applied to the surface of the barrier layer to form an adhesive layer (thickness after curing: 3 μm) on the barrier layer. Then, an unstretched polypropylene film (CPP, with a thickness of 70 μm as shown in Table 1 A) as the heat-sealable resin layer was laminated onto the adhesive layer using a dry lamination method. Next, the resulting laminate was aged and heated to give a power storage device packaging material sequentially having the base material layer/the adhesive agent layer/the barrier layer/the adhesive layer/the heat-sealable resin layer.

<Measurement of Crystallization Index of Base Material Layer in Power Storage Device Packaging Material>

The power storage device packaging material was cut into a 100 mm×100 mm square. Next, a measurement sample was prepared by cutting (slicing) the PET film from the base material layer to expose the surface of the ONy film, using the following procedure. To expose the surface of the polyamide film, an ultramicrotome (for example, Leica EM UC7 from Leica Microsystems) was used to horizontally slice the polyester film in the measurement sample to cut away the polyester film and the adhesive agent layer approximately in the parallel direction. Next, the surface of the ONy film positioned on an outer side of the resulting measurement sample was subjected to infrared absorption spectrum measurement in an environment at a temperature of 25° C. and a relative humidity of 50%, using the ATR measurement mode of Nicolet iS10 FT-IR from Thermo Fisher Scientific Co., Ltd. From the obtained absorption spectrum, the peak intensity P near 1200 cm⁻¹ due to the absorption of the α-crystal of nylon and the peak intensity Q near 1370 cm⁻¹ due to absorption not associated with the crystal were measured, and the intensity ratio of the peak intensity P to the peak intensity Q, X=P/Q, was calculated as the crystallization index. The results are shown in Table 1 A.
(Measurement Conditions)
Method: Macro ATR
Wavenumber resolution: 8 cm⁻¹
Accumulation times: 32
Detector: DTGS detector
ATR prism: Ge
Incident angle: 45°
Baseline: The baseline was obtained by connecting two points, i.e., the first valley on the low wavenumber side of the absorption peak intensity Y₁₂₀₀ and the first valley on the high wavenumber side of the absorption peak intensity Y₁₃₇₀, with a straight line. See the schematic diagram in FIG. 8. In FIG. 8, the right side of the horizontal axis (WAVENUMBER) corresponds to the low wavelength side, and the left side of the horizontal axis (WAVENUMBER) corresponds to the high wavelength side. The position indicated by M is “the first valley on the low wavenumber side of the absorption peak intensity Y₁₂₀₀”, and the position indicated by N is “the first valley on the high wavenumber side of the absorption peak intensity Y₁₃₇₀”.
Absorption peak intensity Y₁₂₀₀: a value obtained by subtracting the baseline value from the maximum value of peak intensity in the wavenumber range of 1195 cm⁻¹ to 1205 cm⁻¹
Absorption peak intensity Y₁₃₇₀: a value obtained by subtracting the baseline value from the maximum value of peak intensity in the wavenumber range of 1365 cm⁻¹ to 1375 cm⁻¹

<Measurement of Crystallization Index of Stretched Nylon Film>

The stretched nylon film used in the base material layer of the power storage device packaging material was cut into a 100 mm×100 mm square to prepare a sample. The surface of the stretched nylon film of the resulting sample was subjected to infrared absorption spectrum measurement in an environment at a temperature of 25° C. and a relative humidity of 50%, using the ATR measurement mode of Nicolet iS10 FT-IR from Thermo Fisher Scientific Co., Ltd. From the obtained absorption spectrum, the peak intensity P near 1200 cm⁻¹ due to the absorption of the α-crystal of nylon and the peak intensity Q near 1370 cm⁻¹ due to absorption not associated with the crystal were measured, and the intensity ratio of the peak intensity P to the peak intensity Q, X=P/Q, was calculated as the crystallization index. The results are shown in Table 1A.
(Measurement Conditions)
Method: Macro ATR
Wavenumber resolution: 8 cm⁻¹
Accumulation times: 32
Detector: DTGS detector
ATR prism: Ge
Incident angle: 45°
Baseline: The baseline was obtained by connecting two points, i.e., the first valley on the low wavenumber side of the absorption peak intensity Y₁₂₀₀ and the first valley on the high wavenumber side of the absorption peak intensity Y₁₃₇₀, with a straight line. See the schematic diagram in FIG. 8. In FIG. 8, the right side of the horizontal axis (WAVENUMBER) corresponds to the low wavelength side, and the left side of the horizontal axis (WAVENUMBER) corresponds to the high wavelength side. The position indicated by M is “the first valley on the low wavenumber side of the absorption peak intensity Y₁₂₀₀”, and the position indicated by N is “the first valley on the high wavenumber side of the absorption peak intensity Y₁₃₇₀”.
Absorption peak intensity Y₁₂₀₀: a value obtained by subtracting the baseline value from the maximum value of peak intensity in the wavenumber range of 1195 cm⁻¹ to 1205 cm⁻¹
Absorption peak intensity Y₁₃₇₀: a value obtained by subtracting the baseline value from the maximum value of peak intensity in the wavenumber range of 1365 cm⁻¹ to 1375 cm⁻¹

<Evaluation of Curling after Molding>

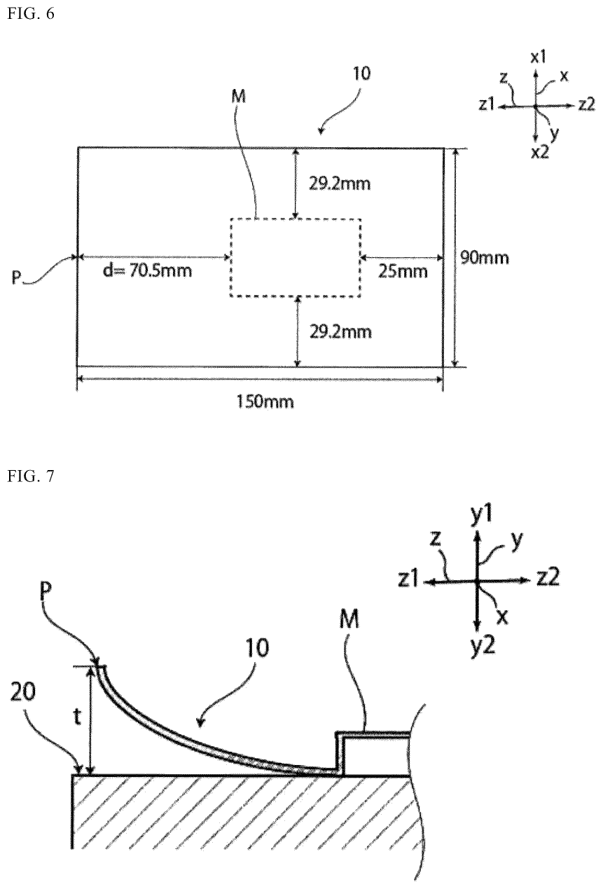

Each power storage device packaging material obtained above was cut into a rectangular piece with a size of 150 mm in the transverse direction (TD)×90 mm in the machine direction (MD) for use as a test sample. A mold was used having a rectangular male die with a size of 31.6 mm×54.5 mm (with a surface having a maximum height of roughness profile (nominal value of Rz) of 1.6 μm, as specified in Table 2 of JIS B 0659-1: 2002 Appendix 1 (Referential) Surface Roughness Standard Specimens for Comparison; corner R: 2.0 mm; ridge R: 1.0 mm) and a female die (with a surface having a maximum height of roughness profile (nominal value of Rz) of 3.2 μm, as specified in Table 2 of JIS B 0659-1: 2002 Appendix 1 (Referential) Surface Roughness Standard Specimens for Comparison; corner R: 2.0 mm; ridge R: 1.0 mm), with a clearance of 0.3 mm between the female die and male die. The test sample was placed on the female die such that the heat-sealable resin layer side was positioned on the male die side, and cold-molded (draw-in one-step molding) by pressing at a pressing pressure (surface pressure) of 0.9 MPa to give a molding depth of 5 mm. The details of the molded position are as shown in FIG. 6. As shown in FIG. 6, the test sample was molded at a position where the shortest distance d between the rectangular molded portion M and the end P of the power storage device packaging material 10 was 70.5 mm. The molded portion M indicates the position where a concave portion was formed with the mold. Next, as shown in FIG. 7, the molded power storage device packaging material 10 was placed on the horizontal surface 20, and the maximum value t of the distance in the vertical direction y from the horizontal surface 20 to the end P was determined as the maximum height of the curled portion (the angle having the maximum height of the heights of the four angles of the test sample). The smaller the value, the smaller the curling after molding and thus, the better the power storage device packaging material. The value of curling after molding (mm) was obtained by rounding the maximum value t to the nearest integer. Curing after molding was evaluated based on the following criteria. The results are shown in Table 1 A.
A+: The curling after molding was 0 mm or more and less than 15 mm. The curling after molding was small, with little or no decrease in productivity.
A: The curling after molding was 15 mm or more and less than 25 mm. The curling after molding was slightly large, with only a small decrease in productivity.
B: The curling after molding was 25 mm or more and less than 35 mm. The curling after molding was large, with a large decrease in productivity.
C: The curling after molding was 35 mm or more. The curling after molding was very large, with a very large decrease in productivity.

<Evaluation of Moldability>

Each power storage device packaging material was cut into a rectangle with a length (machine direction (MD)) of 90 mm and a width (transverse direction (TD)) of 150 mm for use as a test sample. Using a rectangular molding die with an opening size of 31.6 mm (MD direction)×54.5 mm (TD direction) (female die; with a surface having a maximum height of roughness profile (nominal value of Rz) of 3.2 μm, as specified in Table 2 of JIS B 0659-1: 2002 Appendix 1 (Referential) Surface Roughness Standard Specimens for Comparison; corner R: 2.0 mm; ridge R: 1.0 mm) and a corresponding molding die (male die; with a surface having a maximum height of roughness profile (nominal value of Rz) of 1.6 μm, as specified in Table 2 of JIS B 0659-1: 2002 Appendix 1 (Referential) Surface Roughness Standard Specimens for Comparison; corner R: 2.0 mm; ridge R: 1.0 mm), ten samples as described above for each power storage device packaging material were cold-molded (draw-in one-step molding) at a pressing pressure (surface pressure) of 0.9 MPa while varying the molding depth from a molding depth of 5 mm in 0.5 mm increments. Here, molding was performed with the test sample being placed on the female die such that the heat-sealable resin layer side was positioned on the male die side. The clearance between the male die and the female die was 0.3 mm. The cold-molded samples were inspected for pinholes or cracks in the aluminum alloy foil, by directing light to the samples with a penlight in a dark room and allowing the light to pass therethrough. The deepest molding depth at which no pinholes or cracks occurred in the aluminum alloy foil for all the ten samples was defined as A mm, and the number of samples in which pinholes or the like occurred at the shallowest molding depth at which the pinholes or the like occurred in the aluminum alloy foil was defined as B. The value calculated using the equation shown below was rounded off to the first decimal place, and the result was employed as the limit molding depth of the power storage device packaging material. The evaluation was made separately for power storage device packaging materials in which the base material layer had a thickness of 20 μm and power storage device packaging materials in which the base material layer had a thickness of 15 μm. For each power storage device packaging material, the evaluation was made based on the four levels of criteria of depth as shown below. The results are shown in Table 1A.

limit molding depth=A mm+(0.5 mm/10)×(10−B)
A: limit molding depth of 9.5 mm or more
B: limit molding depth of 8.0 mm or more and less than 9.5 mm
C: limit molding depth of 6.5 mm or more and less than 8.0 mm
D: limit molding depth of less than 6.5 mm

<Four-Folding Test>

Each power storage device packaging material obtained above was cut into a rectangular piece with a size of 150 mm in the transverse direction (TD)×90 mm in the machine direction (MD) for use as a test sample. The operation of folding the test sample into four was performed 10 times, and the number of times until a pinhole formed in the central portion was measured. The four-folding operation involved folding the test sample into two at the center position in the TD direction such that the short sides (the sides in the MD direction) were overlaid with each other and the heat-sealable resin layers were overlaid with each other, and then folding the test sample into two at the center position in the MD direction such that the sides in the TD direction were overlaid with each other, so as to fold the test sample into four at the center position of the test sample. This operation was counted as one time. The test was performed by further repeating the operation of unfolding the four-folded test sample and folding the test sample into four in the same manner, and the operation of unfolding the test sample. The number of test samples was five for each power storage device packaging material, and the average value of the number of times until a pinhole formed in the central portion was determined. When the number of test samples was insufficient and five test samples could not be measured, a number of test samples that could be measured were measured, and the average value was determined. The evaluation criteria are as follows:
A: The number of times until a pinhole formed in the central portion was 7 or more.
B: The number of times until a pinhole formed in the central portion was 5 or more and 6 or less.
C: The number of times until a pinhole formed in the central portion was 2 or more and 4 or less.
D: The number of times until a pinhole formed in the central portion was 1.

TABLE 1A

| | | | Crystallization Index (FT-IR ATR) | | | | |
|---|---|---|---|---|---|---|---|
| | | | Stretched Nylon | | | | |
| | | | Film in Base | | | | |
| | Power Storage Device Packaging Material | | Material Layer of | | | | Mechanical |
| | Laminated | Total | Power Storage | | Curling | | Strength |
| | Structure | Thickness | Device Packaging | Stretched | after | | (Four [symbol] Folding |
| | (μm) | (μm) | Material | Nylon Film | Molding | Moldability | Test) |
| Ex. 1A | PET(12)/DL(3)/ON [symbol] (20)/DL(3)/ | 148 | 1.72 | 1.73 | A | A | A |
| | ALM(35)/PPa(37.5)/PP(37.5) | | | | | | |
| Ex. 2A | PET(12)/DL(3)/ON [symbol] (20)/DL(3)/ | 148 | 1.68 | 1.64 | A | A | A |
| | ALM(35)/PPa(37.5)/PP(37.5) | | | | | | |
| Ex. 3A | PET(12)/DL(3)/ON [symbol] (20)/DL(3)/ | 151 | 1.72 | 1.73 | A | A | A |
| | ALM(40)/DL-PPa(3)/CPP(70) | | | | | | |
| Ex. 4A | PET(12)/DL(3)/ON [symbol] (20)/DL(3)/ | 151 | 1.68 | 1.64 | A | A | A |
| | ALM(40)/DL-PPa(3)/CPP(70) | | | | | | |
| Ex. 5A | PET(12)/DL(3)/ON [symbol] (20)/DL(3)/ | 153 | 1.72 | 1.73 | A | A | A |
| | ALM(40)/PPa(37.5)/PP(37.5) | | | | | | |
| Ex. 6A | PET(12)/DL(3)/ON [symbol] (20)/DL(3)/ | 153 | 1.68 | 1.64 | A | A | A |
| | ALM(40)/PPa(37.5)/PP(37.5) | | | | | | |
| Ex. 7A | PET(12)/DL(3)/ON [symbol] (20)/DL(3)/ | 158 | 1.72 | 1.73 | A | A | A |
| | ALM(40)/PPa(40)/PP(40) | | | | | | |
| Ex. 8A | PET(12)/DL(3)/ON [symbol] (20)/DL(3)/ | 158 | 1.68 | 1.64 | A | A | A |
| | ALM(40)/PPa(40)/PP(40) | | | | | | |
| Comp. | PET(12)/DL(3)/ON [symbol] (25)/DL(3)/ | 148 | 1.72 | 1.73 | C | A | A |
| Ex. 1A | ALM(35)/PPa(35)/PP(35) | | | | | | |
| Comp. | PET(12)/DL(3)/ON [symbol] (25)/DL(3)/ | 148 | 1.68 | 1.64 | C | A | A |
| Ex. 2A | ALM(35)/PPa(35)/PP(35) | | | | | | |
| Comp. | PET(12)/DL(3)/ON [symbol] (25)/DL(3)/ | 153 | 1.72 | 1.73 | B | A | A |
| Ex. 3A | ALM(40)/PPa(35)/PP(35) | | | | | | |
| Comp. | PET(12)/DL(3)/ON [symbol] (25)/DL(3)/ | 153 | 1.68 | 1.64 | B | A | A |
| Ex. 4A | ALM(40)/PPa(35)/PP(35) | | | | | | |
| Comp. | PET(12)/DL(3)/ON [symbol] (25)/DL(3)/ | 153 | 1.42 | 1.42 | B | B | B |
| Ex. 5A | ALM(40)/PPa(35)/PP(35) | | | | | | |
| Comp. | PET(12)/DL(3)/ON [symbol] (15)/DL(3)/ | 148 | 1.72 | 1.73 | A+ | C | B |
| Ex. 6A | ALM(35)/PPa(40)/PP(40) | | | | | | |
| Comp. | PET(12)/DL(3)/ON [symbol] (15)/DL(3)/ | 148 | 1.68 | 1.64 | A+ | C | B |
| Ex. 7A | ALM(35)/PPa(40)/PP(40) | | | | | | |
| Comp. | PET(12)/DL(3)/ON [symbol] (15)/DL(3)/ | 153 | 1.72 | 1.73 | A+ | C | B |
| Ex. 8A | ALM(40)/PPa(40)/PP(40) | | | | | | |
| Comp. | PET(12)/DL(3)/ON [symbol] (15)/DL(3)/ | 153 | 1.68 | 1.64 | A+ | C | B |
| Ex. 9A | ALM(40)/PPa(40)/PP(40) | | | | | | |

[symbol]

indicates data missing or illegible when filed

In the Laminated Structure shown in Table 1A, “/” indicates a separation of layers, and the numerical values in parentheses indicate the thickness (μm) of each layer. “PET” indicates a polyethylene terephthalate film; “DL” indicates an adhesive agent layer formed using a dry lamination method with a two-liquid urethane adhesive; “ONy” indicates a stretched nylon film; “ALM” indicates an aluminum alloy foil; “PPa” indicates an adhesive layer formed of a maleic anhydride-modified polypropylene; “DL-PPa” indicates an adhesive layer formed using a dry lamination method with a two-liquid curable adhesive (an acid-modified polypropylene and an epoxy compound); “PP” indicates a heat-sealable resin layer formed of a random polypropylene; and “CPP” indicates a heat-sealable resin layer formed of an unstretched polypropylene film.

As described above, the present disclosure provides the first aspect of the invention as itemized below:
Item 1A. A power storage device packaging material comprising a laminate comprising at least a base material layer, a barrier layer, and a heat-sealable resin layer sequentially from an outer side,
   wherein the base material layer comprises a polyester film and a polyamide film,
   the polyester film has a thickness of 10 μm or more and 14 μm or less, and
   the polyamide film has a thickness of 18 μm or more and 22 μm or less.
Item 2A. The power storage device packaging material according to item 1, wherein the polyamide film has a crystallization index of 1.50 or more as measured by Fourier transform infrared spectroscopy using ATR.
Item 3A. The power storage device packaging material according to item 1A or 2A, wherein the barrier layer has a thickness of 31 μm or more and 45 μm or less.
Item 4A. The power storage device packaging material according to any one of items 1A to 3A, wherein the heat-sealable resin layer has a thickness of 30 μm or more and 40 μm or less.
Item 5A. The power storage device packaging material according to any one of items 1A to 4A, wherein the power storage device packaging material comprises an adhesive layer between the barrier layer and the heat-sealable resin layer, and the adhesive layer has a thickness of 30 μm or more and 40 μm or less.
Item 6A. The power storage device packaging material according to any one of items 1A to 5A, wherein the laminate has a thickness of 165 μm or less.
Item 7A. The power storage device packaging material according to any one of items 1A to 6A, wherein the heat-sealable resin layer is formed of two or more layers using the same resin or different resins.
Item 8A. The power storage device packaging material according to any one of items 1A to 7A, wherein at least one of a surface and an inside of the base material layer contains two or more lubricants.
Item 9A. The power storage device packaging material according to any one of items 1A to 8A, wherein at least one of a surface and an inside of the heat-sealable resin layer contains two or more lubricants.
Item 10A. The power storage device packaging material according to any one of items 1A to 9A, wherein the barrier layer has a thickness of 45 μm or more.
Item 11A. A method for producing a power storage device packaging material comprising the step of providing a laminate in which at least a base material layer, a barrier layer, and a heat-sealable resin layer are laminated sequentially from an outer side,
   wherein the base material layer comprises a polyester film and a polyamide film,
   the polyester film has a thickness of 10 μm or more and 14 μm or less, and
   the polyamide film has a thickness of 18 μm or more and 22 μm or less.
Item 12A. The method according to item 11A, wherein the power storage device packaging material comprises an adhesive layer between the barrier layer and the heat-sealable resin layer, and
   the adhesive layer and the heat-sealable resin layer are laminated by co-extrusion.
Item 13A. The method according to item 11A or 12A, wherein the heat-sealable resin layer is formed of two or more layers using the same resin or different resins.
Item 14A. A power storage device comprising a power storage device element comprising at least a positive electrode, a negative electrode, and an electrolyte, the power storage device element being housed in a package formed of the power storage device packaging material according to any one of items 1A to 10A.

<Production of Power Storage Device Packaging Materials>

### Example 1B

As a base material layer, a stretched nylon (ONy) film (thickness: 12 μm) was prepared. As a barrier layer, a stainless steel foil (SUS304 (thickness: 20 μm)) was prepared. Next, an adhesive (a two-liquid urethane adhesive containing a colorant) was used to laminate the barrier layer and the base material layer using a dry lamination method, and then the resulting laminate was subjected to aging treatment to prepare a laminate of the base material layer/the adhesive agent layer/the barrier layer. Both surfaces of the stainless steel foil had been subjected to chemical conversion treatment. The chemical conversion treatment of the stainless steel foil was performed by applying a treatment solution containing a phenol resin, a chromium fluoride compound, and phosphoric acid to both surfaces of the stainless steel foil using a roll coating method such that the amount of chromium applied was 10 mg/m² (dry mass), and baking.

Next, the barrier layer of the laminate obtained above was bonded to a heat-sealable resin layer using a dry lamination method, using a modified olefin adhesive as an adhesive layer (the thickness of the adhesive layer after curing was 3 μm), to laminate the adhesive layer and the heat-sealable resin layer on the barrier layer. An unstretched polypropylene film (thickness: 23 μm) was used as the heat-sealable resin layer. Then, the surface of the base material layer of the resulting laminate was coated with the below-described resin composition 1 at a thickness of 3 μm and cured in an environment at a temperature of 40 to 100° C. for 3 days to form a matted surface coating layer. This resulted in a power storage device packaging material formed of a laminate (total thickness: 64 μm) having the surface coating layer (3 μm)/the base material layer (thickness: 12 μm)/the adhesive agent layer (3 μm)/the barrier layer (20 μm)/the adhesive layer (3 μm)/the heat-sealable resin layer (23 μm) sequentially from the outer side.

### Example 2B

A power storage device packaging material formed of a laminate (total thickness: 61 μm) having the base material layer (thickness: 12 μm)/the adhesive agent layer (3 μm)/the barrier layer (20 μm)/the adhesive layer (3 μm)/the heat-sealable resin layer (23 μm) sequentially from the outer side was produced as in Example 1B, except that a surface coating layer was not provided on the surface of the base material layer.

### Example 3B

A power storage device packaging material formed of a laminate (total thickness: 62 μm) having the surface coating layer (3 μm)/the base material layer (thickness: 10 μm)/the adhesive agent layer (3 μm)/the barrier layer (20 μm)/the adhesive layer (3 μm)/the heat-sealable resin layer (23 μm) sequentially from the outer side was produced as in Example 1B, except that a stretched nylon (ONy) film (thickness: 10 μm) with a crystallization index different from that in Examples 1B and 2B was used as the base material layer.

### Example 4B

As a base material layer, a stretched nylon (ONy) film (thickness: 25 μm) with a crystallization index different from those in Examples 1B to 3B was prepared. As a barrier layer, a stainless steel foil (SUS304 (thickness: 20 μm)) was prepared. Next, an adhesive (a two-liquid urethane adhesive) was used to laminate the barrier layer and the base material layer using a dry lamination method, and then the resulting laminate was subjected to aging treatment to prepare a laminate of the base material layer/the adhesive agent layer/the barrier layer. Both surfaces of the stainless steel foil had been subjected to chemical conversion treatment. The chemical conversion treatment of the stainless steel foil was performed by applying a treatment solution containing a phenol resin, a chromium fluoride compound, and phosphoric acid to both surfaces of the stainless steel foil using a roll coating method such that the amount of chromium applied was 10 mg/m² (dry mass), and baking.

Next, a maleic anhydride-modified polypropylene as an adhesive layer (thickness: 23 μm) and a random polypropylene as a heat-sealable resin layer (thickness: 23 μm) were co-extruded on the barrier layer of the laminate obtained above to laminate the adhesive layer/the heat-sealable resin layer on the barrier layer, and the resulting laminate was aged. This resulted in a laminate (total thickness: 94 μm) having the base material layer (thickness: 25 μm)/the adhesive agent layer (3 μm)/the barrier layer (20 μm)/the adhesive layer (23 μm)/the heat-sealable resin layer (23 μm) sequentially from the outer side.

### Comparative Example 1B

A laminate (total thickness: 114 μm) having the base material layer (thickness: 25 μm)/the adhesive agent layer (3 μm)/the barrier layer (40 μm)/the adhesive layer (23 μm)/the heat-sealable resin layer (23 μm) was produced as in Example 4B, except that an aluminum alloy foil (JIS H4160: 1994 A8021 H-O (thickness: 40 μm)) was used as the barrier layer. Both surfaces of the aluminum alloy foil had been subjected to chemical conversion treatment. The chemical conversion treatment of the aluminum alloy foil was performed by applying a treatment solution containing a phenol resin, a chromium fluoride compound, and phosphoric acid to both surfaces of the aluminum alloy foil using a roll coating method such that the amount of chromium applied was 10 mg/m² (dry mass), and baking.

### Comparative Example 2B

A laminate (total thickness: 114 μm) having the base material layer (thickness: 25 μm)/the adhesive agent layer (3 μm)/the barrier layer (40 μm)/the adhesive layer (23 μm)/the heat-sealable resin layer (23 μm) was produced as in Comparative Example 1, except that a stretched nylon (ONy) film (thickness: 25 μm) with a crystallization index different from that in Comparative Example 1 was used as the base material layer.

### Comparative Example 3B

A laminate (total thickness: 114 μm) having the base material layer (thickness: 25 μm)/the adhesive agent layer (3 μm)/the barrier layer (40 μm)/the adhesive layer (23 μm)/the heat-sealable resin layer (23 μm) was produced as in Comparative Example 1, except that a stretched nylon (ONy) film (thickness: 25 μm) with a crystallization index different from those in Comparative Examples 1 and 2 was used as the base material layer.

<Measurement of Crystallization Index of Base Material Layer in Power Storage Device Packaging Material>

The power storage device packaging material was cut into a 100 mm×100 mm square to prepare a sample. The surface of the stretched nylon film positioned on the outer side of the resulting sample was subjected to infrared absorption spectrum measurement in an environment at a temperature of 25° C. and a relative humidity of 50%, using the ATR measurement mode of Nicolet iS10 FT-IR from Thermo Fisher Scientific Co., Ltd. From the obtained absorption spectrum, the peak intensity P near 1200 cm⁻¹ due to the absorption of the α-crystal of nylon and the peak intensity Q near 1370 cm⁻¹ due to absorption not associated with the crystal were measured, and the intensity ratio of the peak intensity P to the peak intensity Q, X=P/Q, was calculated as the crystallization index. The samples of Examples 1B and 3B were subjected to the measurement before the application of the surface coating layer. The results are shown in Table 1B.
(Measurement Conditions)
Method: Macro ATR
Wavenumber resolution: 8 cm⁻¹
Accumulation times: 32
Detector: DTGS detector
ATR prism: Ge
Incident angle: 45°
Baseline: The baseline was obtained by connecting two points, i.e., the first valley on the low wavenumber side of the absorption peak intensity Y₁₂₀₀ and the first valley on the high wavenumber side of the absorption peak intensity Y₁₃₇₀, with a straight line. See the schematic diagram in FIG. 8. In FIG. 8, the right side of the horizontal axis (WAVENUMBER) corresponds to the low wavelength side, and the left side of the horizontal axis (WAVENUMBER) corresponds to the high wavelength side. The position indicated by M is “the first valley on the low wavenumber side of the absorption peak intensity Y₁₂₀₀”, and the position indicated by N is “the first valley on the high wavenumber side of the absorption peak intensity Y₁₃₇₀”.
Absorption peak intensity Y₁₂₀₀: a value obtained by subtracting the baseline value from the maximum value of peak intensity in the wavenumber range of 1195 cm⁻¹ to 1205 cm⁻¹
Absorption peak intensity Y₁₃₇₀: a value obtained by subtracting the baseline value from the maximum value of peak intensity in the wavenumber range of 1365 cm⁻¹ to 1375 cm⁻¹

<Measurement of Crystallization Index of Stretched Nylon Film>

The stretched nylon film used as the base material layer of the power storage device packaging material was cut into a 100 mm×100 mm square to prepare a sample. The surface of the resulting sample was subjected to infrared absorption spectrum measurement in an environment at a temperature of 25° C. and a relative humidity of 50%, using the ATR measurement mode of Nicolet iS10 FT-IR from Thermo Fisher Scientific Co., Ltd. From the obtained absorption spectrum, the peak intensity P near 1200 cm⁻¹ due to the absorption of the α-crystal of nylon and the peak intensity Q near 1370 cm⁻¹ due to absorption not associated with the crystal were measured, and the intensity ratio of the peak intensity P to the peak intensity Q, X=P/Q, was calculated as the crystallization index. The results are shown in Table 1B.
(Measurement Conditions)
Method: Macro ATR
Wavenumber resolution: 8 cm⁻¹
Accumulation times: 32
Detector: DTGS detector
ATR prism: Ge
Incident angle: 45°
Baseline: The baseline was obtained by connecting two points, i.e., the first valley on the low wavenumber side of the absorption peak intensity Y₁₂₀₀ and the first valley on the high wavenumber side of the absorption peak intensity Y₁₃₇₀, with a straight line. See the schematic diagram in FIG. 8. In FIG. 8, the right side of the horizontal axis (WAVENUMBER) corresponds to the low wavelength side, and the left side of the horizontal axis (WAVENUMBER) corresponds to the high wavelength side. The position indicated by M is “the first valley on the low wavenumber side of the absorption peak intensity Y₁₂₀₀”, and the position indicated by N is “the first valley on the high wavenumber side of the absorption peak intensity Y₁₃₇₀”.
Absorption peak intensity Y₁₂₀₀: a value obtained by subtracting the baseline value from the maximum value of peak intensity in the wavenumber range of 1195 cm⁻¹ to 1205 cm⁻¹
Absorption peak intensity Y₁₃₇₀: a value obtained by subtracting the baseline value from the maximum value of peak intensity in the wavenumber range of 1365 cm⁻¹to 1375 cm⁻¹

<Evaluation of Damage Resistance at 110° C.>

The power storage device packaging material was cut into a rectangle with a width (transverse direction (TD)) of 30 mm and a length (machine direction (MD)) of 100 mm for use as a test piece. Next, the test piece was placed on a 150 mm square flat glass plate with the surface coating layer facing upward in Example 1B or 3B or with the base material layer facing upward in Example 2B or 4B, or Comparative Example 1B, 2B or 3B, and the ends of the test piece were fixed with tape such that the heat-sealable resin layer was brought in close contact with the glass plate. In this state, the test piece was allowed to stand in an oven at 110° C. for 10 minutes. Next, the test piece was removed from the oven and immediately subjected to the following process: A ruler was placed on the surface coating layer of the test piece of Example 1B or 3B or on the base material layer of the test piece of Example 2B or 4B, or Comparative Example 1B, 2B or 3B, and the surface of the surface coating layer of the test piece of Example 1B or 3B or the surface of the base material layer of the test piece of Example 2B or 4B, or Comparative Example 1B, 2B or 3B was scratched with a pencil having a pointed tip (the pencil had a pencil lead hardness of 2H). Next, the test piece was removed from the glass plate, and the heat-sealable resin layer-side surface was observed to evaluate damage resistance at 110° C. of the power storage device packaging material, based on the criteria as shown below. The results are shown in Table 1B.
A: No convex shape or clear streaks were observed on the heat-sealable resin layer side. That is, neither convex shape nor clear streaks were observed on the heat-sealable resin layer side.
B: A slight convex shape was observed on the heat-sealable resin layer side, but no clear streaks were observed.
C: A large convex shape and (and/or) clear streaks were observed on the heat-sealable resin layer side.

<Evaluation of Damage Resistance at 30° C.>

The power storage device packaging material was cut into a rectangle with a width (transverse direction (TD)) of 30 mm and a length (machine direction (MD)) of 100 mm for use as a test piece. Next, the test piece was placed on a 150 mm square flat glass plate with the surface coating layer facing upward in Example 1B or 3B or with the base material layer facing upward in Example 2B or 4B, or Comparative Example 1B, 2B or 3B, and the ends of the test piece were fixed with tape such that the heat-sealable resin layer was brought in close contact with the glass plate. In this state, the test piece was placed in an environment at 30° C. A ruler was placed on the surface coating layer of the test piece of Example 1 B or 3B or on the base material layer of the test piece of Example 2B or 4B, or Comparative Example 1 B, 2B or 3B, and the surface of the surface coating layer of the test piece of Example 1B or 3B or the surface of the base material layer of the test piece of Example 2B or 4B, or Comparative Example 1B, 2B or 3B was scratched with a pencil having a pointed tip (the pencil had a pencil lead hardness of 2H). Next, the test piece was removed from the glass plate, and the heat-sealable resin layer-side surface was observed to evaluate damage resistance at 110° C. of the power storage device packaging material, based on the criteria as shown below. The results are shown in Table 1 B.
A: No convex shape or clear streaks were observed on the heat-sealable resin layer side. That is, neither convex shape nor clear streaks were observed on the heat-sealable resin layer side.
B: A slight convex shape was observed on the heat-sealable resin layer side, but no clear streaks were observed.
C: A large convex shape and (and/or) clear streaks were observed on the heat-sealable resin layer side.

<Power Storage Device Separation Test>

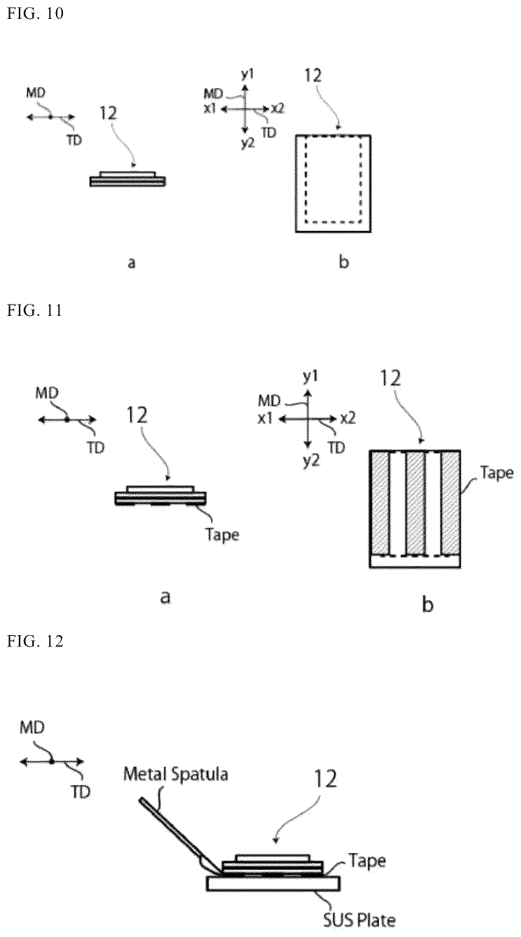

A power storage device separation test was performed using the following procedure. The procedure is described with reference to FIGS. 9 to 12. A procedure for preparing a sample for use in the power storage device separation test is described first with reference to FIG. 9. As shown in FIG. 9a, the power storage device packaging material was cut into a rectangle with a length (MD) of 200 mm and a width (TD) of 90 mm. Next, using a molding die (female die) with an opening size of 55 mm in length (MD)×32 mm in width (TD) and a corresponding molding die (male die), the power storage device packaging material was cold-molded to a depth of 5.0 mm from the heat-sealable resin layer side, at a position 15 mm away from a short side thereof, to form a concave portion M (the area surrounded by the dashed line in FIG. 9a). Next, an acrylic plate with a length of 55 mm, a width of 32 mm, and a thickness of 5 mm was inserted into the concave portion M (FIGS. 9b and 9c). Next, the molded power storage device packaging material was folded into two in the TD direction at the position of the fold P (the position along a short side of the concave portion M) such that the concave portion M was positioned on the inner side (FIG. 9d). Next, portions where the heat-sealable resin layers were overlaid with each other, along the periphery of the concave portion M, were heat-sealed (190° C., 3 sec, surface pressure 1 MPa) in three areas along the MD and TD to hermetically seal the concave portion M (FIG. 9e). In FIG. 9e, the shaded regions S are the heat-sealed portions. Next, as shown in FIG. 9f, the power storage device packaging material was trimmed into a size of 60 mm in length (MD) and 37 mm in width (TD) along the concave portion M to prepare a sample 12 for use in the power storage device separation test. FIG. 10(a) is a side view and FIG. 10(b) is a plan view of the sample 12.

Next, as shown in the schematic diagram of FIG. 11, three pieces of a double-sided tape (width: 7.5 mm, length: 55 mm) were applied to a central position and both end positions on the flat-side surface of the sample 12 (surface opposite to the surface having the concave portion M) along the longitudinal direction (MD). The peeling strength of the double-sided tape with respect to an adherend was measured using the below-described method.

Next, the sample 12 to which the double-sided tape was applied was attached to a stainless steel plate and allowed to cure in an environment at 60° C. for 24 hours. The stainless steel plate imitated a casing to which a power storage device is fixed with a double-sided tape. Next, as shown in the schematic diagram of FIG. 12, the sample 12 was carefully separated from the stainless steel plate using a metal spatula, and the separated sample 12 was visually inspected for the presence or absence of holes. Three samples for each power storage device packaging material were evaluated in the power storage device separation test, based on the criteria as shown below. As shown in FIG. 12, the power storage device was separated by applying a force in the width direction (TD) of the sample 12. The results are shown in Table 1B.
A: All the three samples had no holes.
B: One or two samples had holes.
C: All the three samples had holes.

TABLE 1B

| | | | | Evaluation of Damage | | Evaluation of |
|---|---|---|---|---|---|---|
| | Crystallization Index (FT-IR ATR) | | | Resistance of Power | | Power Storage |
| | Power Storage Device | | | Storage Device Packaging | | Device |
| | Packaging Material | Stretched | | Material | | Separation |
| | (Base Material Layer) | Nylon Film | Barrier Layer | 110° C. | 30° C. | Test |
| Ex. 1B | 1.71 | 1.72 | Stainless Steel Foil | A | A | A |
| Ex. 2B | 1.71 | 1.72 | Stainless Steel Foil | A | A | A |
| Ex. 3B | 1.72 | 1.73 | Stainless Steel Foil | A | A | A |
| Ex. 4B | 1.68 | 1.64 | Stainless Steel Foil | A | A | A |
| Comp. | 1.68 | 1.64 | Aluminum Alloy Foil | C | C | A |
| Ex.1B | | | | | | |
| Comp. | 1.42 | 1.25 | Aluminum Alloy Foil | C | C | B |
| Ex. 2B | | | | | | |
| Comp. | 1.39 | 1.26 | Aluminum Alloy Foil | C | C | C |
| Ex. 3B | | | | | | |

The power storage device packaging materials of Examples 1B to 4B each comprise a laminate comprising at least a base material layer, a barrier layer, and a heat-sealable resin layer sequentially from an outer side, wherein the base material layer comprises a polyamide film, the barrier layer comprises stainless steel, and the polyamide film has a crystallization index of 1.50 or more as measured from an outer side of the base material layer by Fourier transform infrared spectroscopy using ATR. Moreover, the polyamide film used as the base material layer of each of the power storage device packaging materials of Examples 1B to 4B has a crystallization index of 1.50 or more as measured by Fourier transform infrared spectroscopy using ATR. In the power storage device packaging materials of Examples 1B to 4B, breakage in the power storage device packaging material at the time of separating a power storage device fixed with a double-sided tape or the like from the casing was effectively reduced. Also, in the power storage device packaging material of Comparative Example 1, breakage in the power storage device packaging material at the time of separating a power storage device fixed with a double-sided tape or the like from the casing was effectively reduced. In contrast, in the power storage device packaging materials of Comparative Examples 2 and 3, breakage in the power storage device packaging material was not sufficiently reduced as compared to the power storage device packaging materials of Examples 1B to 4B and Comparative Example 1.

Moreover, the power storage device packaging materials of Examples 1 B to 4B showed no convex shape or clear streaks on the heat-sealable resin layer side in an environment at 30° C., despite using the 2H pencil with a very high lead hardness and thus, were confirmed to be resistant to damage. In contrast, the power storage device packaging materials of Comparative Examples 1B to 3B were more susceptible to this damage than the packaging materials of Examples 1B to 4B.

Furthermore, the power storage device packaging materials of Examples 1B to 4B showed no convex shape or clear streaks on the heat-sealable resin layer side even in a high-temperature environment at 110° C., despite using the 2H pencil with a very high lead hardness and thus, were confirmed to be resistant to damage.

The difference between the crystallization index value measured for the base material layer in the power storage device packaging material and the crystallization index value measured for the stretched nylon film is believed to be due to the effect of aging the power storage device packaging material. The crystallization index values of the stretched nylon films used in Comparative Examples 2B and 3B were significantly smaller than the values of Examples 1B to 4B and Comparative Example 1B; however, the values measured after laminating these stretched nylon films as the base material layers on the power storage device packaging materials were considerably higher than the values measured in the state of stretched nylon films. Nevertheless, in Comparative Examples 2B and 3B, the crystallization index of the polyamide film as measured from the outer side of the base material layer was not increased to 1.50 or more by aging the power storage device packaging material, and the results of the evaluation of the power storage device separation test were inferior to those for Examples 1B to 4B and Comparative Example 1B.

The polyamide film has high hygroscopicity and thus, may easily delaminate in a high temperature and humidity environment as the thickness increases. Thus, the thickness of the polyamide film is preferably smaller from the viewpoint of satisfactorily reducing the delamination in a high temperature and humidity environment. For example, it is assumed that the delamination in a high temperature and humidity environment is less likely to occur in Examples 1B and 2B using a stretched nylon film with a thickness of 12 μm and Example 3B using a stretched nylon film with a thickness of 10 μm than in Example 4B using a stretched nylon film with a thickness of 25 μm.

(Measurement of Peeling Strength of Double-Sided Tape)

The power storage device packaging materials (15 mm in length×70 mm in width) of Example 1B and Comparative Example 1B, the same double-sided tape (7.5 mm in length×60 mm in width) as used in <Power Storage Device Separation Test>, an aluminum foil (35 μm in thickness×15 mm in length×150 mm in width), a double-sided adhesive tape for fixing (5 mm in length×60 mm in width), and an acrylic plate (3 mm in thickness×50 mm in length×70 mm in width) were prepared. First, the stretched nylon film-side surface (or the surface of the surface coating layer on the stretched nylon film in Example 1B) of the power storage device packaging material was bonded to one side of the double-sided tape, and the aluminum foil was bonded to the other side of the double-sided tape, and then a 2 kg roller was reciprocated once on the aluminum foil to give a laminate P. Separately, the acrylic plate was bonded to one side of the double-sided adhesive tape for fixing to give a laminate Q. Then, the heat-sealable resin layer surface of the power storage device packaging material of the laminate P was bonded to the other side of the double-sided adhesive tape for fixing of the laminate Q and pressed by hand to give a laminate R sequentially having the acrylic plate, the double-sided adhesive tape for fixing, the power storage device packaging material, the double-sided tape, and the aluminum foil. The laminate R was used as a test sample M. The test sample M was stored in an environment at a temperature of 60° C. for 24 hours. Next, the stretched nylon film surface of the power storage device packaging material was delaminated from an end portion of the double-sided tape by about 1 mm to form a trigger portion for measuring the peeling strength. Next, the acrylic plate of the test sample M was fixed, and the aluminum foil was pulled using a tensile testing machine (AG-Xplus (trade name) from Shimadzu Corporation) at a pulling angle of 180°, a peeling speed of 300 mm/min, and a peeling distance of 50 mm or more to cause delamination (from the trigger portion described above) at the interface between the double-sided tape and the stretched nylon film surface of the power storage device packaging material. The average of a total of five peeling strengths, i.e., peeling strengths at peeling distances of 10 mm, 20 mm, 30 mm, and 40 mm and the maximum peeling strength in the range between 10 mm and 40 mm, was calculated as the peeling strength (peeling strength (N/7.5 mm) of the double-sided tape with respect to the stretched nylon film). The results are shown in Table 2B.

Next, the same stainless steel plate (3 mm in thickness×50 mm in length×70 mm in width) and double-sided tape (7.5 mm in length×60 mm in width) as used in <Power Storage Device Separation Test>, and the above-mentioned aluminum foil (35 μm in thickness×15 mm in length×150 mm in width) were prepared. A surface of the stainless steel plate was bonded to one side of the double-sided tape, and the aluminum foil was bonded to the other side of the double-sided tape, and then a 2 kg roller was reciprocated once on the aluminum foil to give a laminate, which was used as a test sample N. The test sample N was stored in an environment at a temperature of 60° C. for 24 hours. Next, the surface of the stainless steel plate was delaminated from an end portion of the double-sided tape by about 1 mm to form a trigger portion for measuring the peeling strength. Next, the stainless steel plate of the test sample N was fixed, and the aluminum foil was pulled using a tensile testing machine (AG-Xplus (trade name) from Shimadzu Corporation) at a pulling angle of 180°, a peeling speed of 300 mm/min, and a peeling distance of 50 mm or more to cause delamination (from the trigger portion described above) at the interface between the double-sided tape and the surface of the stainless steel plate. The average of a total of five peeling strengths, i.e., peeling strengths at peeling distances of 10 mm, 20 mm, 30 mm, and 40 mm and the maximum peeling strength in the range between 10 mm and 40 mm, was calculated as the peeling strength (peeling strength (N/7.5 mm) of the double-sided tape with respect to the stainless steel plate). The results are shown in Table 2B.

TABLE 2B

| | Peeling Strength |
|---|---|
| | (N/7.5 mm) of |
| | Double-Sided Tape |
| Stretched Nylon Film of Example 1B | 12.3 |
| Stretched Nylon Film of Comparative Example 1B | 12.4 |
| Stainless Steel Plate | 12.2 |

As is evident from the results shown in Table 2B, the double-sided tape used in <Power Storage Device Separation Test> had similar peeling strengths with respect to the stretched nylon films and the stainless steel plate.

As described above, the present disclosure provides the second aspect of the invention as itemized below:
Item 1B. A power storage device packaging material comprising a laminate comprising at least a base material layer, a barrier layer, and a heat-sealable resin layer sequentially from an outer side,
   wherein the base material layer comprises a polyamide film,
   the barrier layer comprises stainless steel, and
   the polyamide film has a crystallization index of 1.50 or more as measured from an outer side of the base material layer by Fourier transform infrared spectroscopy using ATR.
Item 2B. The power storage device packaging material according to item 1B, wherein the laminate has a thickness of 100 μm or less.
Item 3B. The power storage device packaging material according to item 1B or 2B, wherein the base material layer has a thickness of 19 μm or less.
Item 4B. The power storage device packaging material according to any one of items 1B to 3B, wherein the power storage device packaging material has a black color.
Item 5B. The power storage device packaging material according to any one of items 1B to 4B, wherein the power storage device packaging material comprises an adhesive agent layer between the base material layer and the barrier layer.
Item 6B. The power storage device packaging material according to item 5B, wherein the adhesive agent layer comprises a pigment.
Item 7B. The power storage device packaging material according to any one of items 1B to 6B, wherein the power storage device packaging material comprises a coloring layer between the base material layer and the heat-sealable resin layer.
Item 8B. The power storage device packaging material according to any one of items 1B to 7B, wherein the power storage device packaging material comprises an adhesive layer between the barrier layer and the heat-sealable resin layer.
Item 9B. The power storage device packaging material according to any one of items 1B to 8B, wherein the heat-sealable resin layer is formed of two or more layers using the same resin or different resins.
Item 10B. The power storage device packaging material according to any one of items 1B to 9B, wherein at least one of a surface and an inside of the base material layer contains two or more lubricants.
Item 11B. The power storage device packaging material according to any one of items 1B to 10B, wherein at least one of a surface and an inside of the heat-sealable resin layer contains two or more lubricants.
Item 12B. The power storage device packaging material according to any one of items 1B to 11B, wherein the barrier layer has a thickness of 45 μm or more.
Item 13B. The power storage device packaging material according to any one of items 1B to 12B, wherein the power storage device packaging material comprises a surface coating layer on an outer side of the base material layer.
Item 14B. A method for producing a power storage device packaging material comprising the step of providing a laminate in which at least a base material layer, a barrier layer, and a heat-sealable resin layer are laminated sequentially from an outer side,
   wherein the base material layer comprises a polyamide film,
   the barrier layer comprises stainless steel, and
   the polyamide film has a crystallization index of 1.50 or more as measured from an outer side of the base material layer by Fourier transform infrared spectroscopy using ATR.
Item 15B. The method according to item 14B, wherein the power storage device packaging material comprises an adhesive layer between the barrier layer and the heat-sealable resin layer, and
   the adhesive layer and the heat-sealable resin layer are laminated by co-extrusion.
Item 16B. The method according to any one of items 14B or 15B, wherein the heat-sealable resin layer is formed of two or more layers using the same resin or different resins.
Item 17B. A power storage device comprising a power storage device element comprising at least a positive electrode, a negative electrode, and an electrolyte, the power storage device element being housed in a package formed of the power storage device packaging material according to any one of items 1B to 13B.
Item 18B. A polyamide film for use as a base material layer in a power storage device packaging material comprising a laminate comprising at least the base material layer, a barrier layer, and a heat-sealable resin layer,
   wherein the barrier layer comprises stainless steel, and
   the polyamide film has a crystallization index of 1.50 or more as measured by Fourier transform infrared spectroscopy using ATR.

### REFERENCE SIGNS LIST

1: base material layer
2: adhesive agent layer
3: barrier layer
4: heat-sealable resin layer
5: adhesive layer
6: surface coating layer
10: power storage device packaging material
12: sample
20: horizontal surface

1-25. (canceled)

26. A power storage device packaging material comprising a laminate comprising at least a base material layer, a barrier layer, and a heat-sealable resin layer sequentially from an outer side,
wherein the base material layer comprises a polyester film and a polyamide film,
the polyester film has a thickness of 10 μm or more and 14 μm or less, and the polyamide film has a thickness of 18 μm or more and 22 μm or less.

27. The power storage device packaging material according to claim 26, wherein the polyamide film has a crystallization index of 1.50 or more as measured by Fourier transform infrared spectroscopy using ATR.

28. The power storage device packaging material according to claim 26, wherein the barrier layer has a thickness of 31 μm or more and 45 μm or less.

29. The power storage device packaging material according to 26, wherein the heat-sealable resin layer has a thickness of 30 μm or more and 45 μm or less.

30. The power storage device packaging material according to claim 26, wherein the power storage device packaging material comprises an adhesive layer between the barrier layer and the heat-sealable resin layer, and
the adhesive layer has a thickness of 30 μm or more and 50 μm or less.

31. The power storage device packaging material according to claim 26, wherein the laminate has a thickness of 165 μm or less.

32. A power storage device packaging material comprising a laminate comprising at least a base material layer, a barrier layer, and a heat-sealable resin layer sequentially from an outer side,
wherein the base material layer comprises a polyamide film,
the barrier layer comprises stainless steel, and
the polyamide film has a crystallization index of 1.50 or more as measured from an outer side of the base material layer by Fourier transform infrared spectroscopy using ATR.

33. The power storage device packaging material according to claim 32, wherein the laminate has a thickness of 100 μm or less.

34. The power storage device packaging material according to claim 32, wherein the base material layer has a thickness of 19 μm or less.

35. The power storage device packaging material according to claim 32, wherein the power storage device packaging material has a black color.

36. The power storage device packaging material according to claim 32, wherein the power storage device packaging material comprises an adhesive agent layer between the base material layer and the barrier layer.

37. The power storage device packaging material according to claim 36, wherein the adhesive agent layer comprises a pigment.

38. The power storage device packaging material according to claim 32, wherein the power storage device packaging material comprises a coloring layer between the base material layer and the heat-sealable resin layer.

39. The power storage device packaging material according to claim 32, wherein the power storage device packaging material comprises an adhesive layer between the barrier layer and the heat-sealable resin layer.

40. The power storage device packaging material according to claim 32, wherein the power storage device packaging material comprises a surface coating layer on an outer side of the base material layer.

41. The power storage device packaging material according to claim 26, wherein the heat-sealable resin layer is formed of two or more layers using the same resin or different resins.

42. The power storage device packaging material according to claim 26, wherein at least one of a surface and an inside of the base material layer contains two or more lubricants.

43. The power storage device packaging material according to claim 26, wherein at least one of a surface and an inside of the heat-sealable resin layer contains two or more lubricants.

44. The power storage device packaging material according to claim 26, wherein the barrier layer has a thickness of 45 μm or more.

45. A method for producing a power storage device packaging material comprising the step of providing a laminate in which at least a base material layer, a barrier layer, and a heat-sealable resin layer are laminated sequentially from an outer side,
wherein the base material layer comprises a polyester film and a polyamide film,
the polyester film has a thickness of 10 μm or more and 14 μm or less, and
the polyamide film has a thickness of 18 μm or more and 22 μm or less.

46. The method according to claim 45, wherein the power storage device packaging material comprises an adhesive layer between the barrier layer and the heat-sealable resin layer, and
the adhesive layer and the heat-sealable resin layer are laminated by co-extrusion.

47. The method according to claim 45, wherein the heat-sealable resin layer is formed of two or more layers using the same resin or different resins.

48. A power storage device comprising a power storage device element comprising at least a positive electrode, a negative electrode, and an electrolyte, the power storage device element being housed in a package formed of the power storage device packaging material according to claim 26.
